(19) United States
(12) Patent Application Publication
(10) Pub. No.: US 2011/0280033 A1
(43) Pub. Date: Nov. 17, 2011

(54) LIGHT-EMITTING DEVICE, ILLUMINATION DEVICE, AND VEHICLE HEADLAMP

(75) Inventors: Katsuhiko KISHIMOTO, Osaka-shi (JP); Koji Takahashi, Osaka-shi (JP); Yoshitaka Tomomura, Osaka-shi (JP); Hidenori Kawanishi, Osaka-shi (JP)

(73) Assignee: SHARP KABUSHIKI KAISHA, Osaka-shi (JP)

(21) Appl. No.: 13/107,449

(22) Filed: May 13, 2011

(30) Foreign Application Priority Data
May 17, 2010 (JP) 2010-113478
May 17, 2010 (JP) 2010-113481

(51) Int. Cl. B60Q 1/04; F21V 7/22; F21V 29/00

(52) U.S. Cl. 362/543; 362/227; 362/235

(57) ABSTRACT

A headlamp includes: a laser diode for emitting laser beam; a light-emitting section for emitting light when irradiated with the laser beam emitted from the laser diode; and a cooling device for cooling the light-emitting device by use of a fluid. With the arrangement, it is possible to prevent an increase in temperature of the light-emitting section which is irradiated with excitation light, and thereby to realize a light source of long lifetime.

This Nonprovisional application claims priority under 35 U.S.C. §119(a) on Patent Applications Nos. 2010-113478 and 2010-113481 both filed in Japan on May 17, 2010, the entire contents of both of which are hereby incorporated by reference.

### TECHNICAL FIELD

The present invention relates to (i) a light-emitting device which functions as a high-luminance light source, (ii) an illumination device including the light-emitting device, and (iii) a vehicle headlamp including the light-emitting device.

### BACKGROUND ART

Recent years have seen more and more research conducted on a light-emitting device that includes as an excitation light source a semiconductor light-emitting element such as a light-emitting diode (LED) and a laser diode (LD) and that emits, as illumination light, fluorescence generated by a light-emitting section including a fluorescent substance in response to irradiation of excitation light emitted by the excitation light source.

Patent Literatures 1 and 2 each disclose a lamp as an example technique related to the above light-emitting device. To serve as a high-luminance light source, the lamps each include a laser diode as an excitation light source. The laser diode emits a laser beam that is coherent and thus highly directional. This allows the laser beam to be collected without a loss and used as excitation light. A light-emitting device including such a laser diode as an excitation light source is suitably applicable to a vehicle headlamp (such light-emitting device is hereinafter referred to as “LD light-emitting device”).

Patent Literature 3 discloses a surface mount LED element as an example of a lamp including an LED as an excitation light source.

Further, Non Patent Literature 1 discloses a vehicle headlamp that shows an example technique for using, to produce a vehicle headlamp, a white LED that emits incoherent light.

Non Patent Literature 1 discloses (i) narrowing, in a vertical direction, a light distribution pattern (light distribution) of light emitted by a light-emitting section of the vehicle headlamp and (ii) widening the light distribution pattern in a horizontal direction.

### CITATION LIST

### Patent Literature 1

Japanese Patent Application Publication, Tokukai, No. 2005-150041 A (Publication Date: Jun. 9, 2005)

### Patent Literature 2

Japanese Patent Application Publication, Tokukai, No. 2003-295319 A (Publication Date: Oct. 15, 2003)

### Patent Literature 3

Japanese Patent Application Publication, Tokukai, No. 2004-200531 (Publication Date: Jul. 15, 2004)

### Non Patent Literature 1

Hakushoku LED no Jidoushashoumei eno ouyou (Applications of white LEDs to automotive light devices), Masaru Sasaki; OYO BUTURI, Vol. 74, No. 11, pp. 1463-1466 (2005)

### SUMMARY OF INVENTION

### Technical Problem

The inventor of the present invention has found the following problem related to the above techniques: A minute light-emitting section including a fluorescent substance, when excited by high-power excitation light (that is, light having a high power density), suffers significantly from degradation such as property change and lifetime reduction.

A light-emitting section normally includes a fluorescent substance having a luminous efficiency of approximately 50% to 90%. In this case, 10 to 50% of an energy of excitation light is used not in a form of fluorescence but in a form of heat. For instance, in a case of excitation light of 1 W, 0.1 to 0.5 W is used to generate heat. If such heat is generated in a local portion of a minute light-emitting section, such a local portion suffers from a rapid temperature rise and is consequently subjected to property change (for example, brightness decrease and chromaticity change) and lifetime reduction.

More specifically, one cause of degradation of a light-emitting section is a temperature rise in a region of the light-emitting section which region (hereinafter referred to as “temperature elevation region”) includes (i) a first portion (irradiation region) receiving the excitation light and (ii) a second portion surrounding the first portion. On receipt of high-power excitation light (laser beam) from a laser diode, only the temperature elevation region of the light-emitting section is locally heated to an extremely high temperature. This causes a problem that the temperature elevation region is degraded rapidly. A simulation has demonstrated that the temperature elevation region has a temperature that exceeds 500 degrees Celsius even immediately after a start of excitation light irradiation if no heat dissipation treatment has been carried out for the temperature elevation region.

This indicates that in order to prevent degradation of the light-emitting section in a configuration in which a minute light-emitting section including a fluorescent substance is excited by high-power excitation light and thus to produce a light source that emits bright light and has a long lifetime, it is desirable to prevent a temperature rise in the temperature elevation region including the irradiation region and its surrounding region.

Patent Literature 1 discloses a heat dissipating member (heat sink) connected to a light source unit (including the excitation light source and a fluorescent substance). Patent Literature 1, however, fails to disclose which of the excitation light source and the fluorescent substance the heat dissipating member is connected to. Further, Patent Literature 1 merely discloses, as a method of the heat dissipation, contacting with the light source unit a material, such as a metal, which has a thermal conductivity that is higher than that of air.

Patent Literature 3 discloses an arrangement of filling, with a low-melting glass, a space around a light-emitting section including a fluorescent substance dispersed in a low-melting glass. Further, Patent Literature 1 discloses an arrangement of filling a space around a fluorescent substance with a light-transmitting member such as glass and resin. Neither of these documents, however, discusses necessity to purposefully cool a light-emitting section including a fluorescent substance.

In a case where a light-emitting section is coated as above with a material such as glass and resin, it is possible to, although unintentionally, achieve a slight effect of cooling the light-emitting section. Specifically, glass has a thermal conductivity (approximately 1.0 W/mK), which is higher than a thermal conductivity of air (0.02614 W/mK at 27° C. under atmospheric pressure). In the case where a light-emitting section is thus coated with glass, heat of the light-emitting section is allowed to transfer to the glass around it. As such, a temperature rise in the light-emitting section is reduced.

In the case where a light-emitting section is coated with a solid such as glass and resin, it is possible to cool the light-emitting section as long as it emits light for a short time. However, if the light-emitting section emits light for a long time, the glass or resin will suffer from a temperature rise, and it may not be possible to sufficiently cool the light-emitting section as a result. In particular, in a case where a light-emitting section is coated with resin, the resin will highly likely be denatured and discolored by heat so that a decrease in quality and amount of illumination light is caused.

It is possible to reduce intensity (in watt) of excitation light, irradiating a light-emitting section, so that heat generation by a light-emitting section is prevented. According to this method, however, an amount (luminous flux) of light emitted by the light-emitting section will be decreased, and a luminous intensity necessary for a light-emitting device may not be achieved.

Patent Literature 2 discloses a lamp including (i) an excitation light source which includes an LD and (ii) a fluorescent substance which collects and absorbs a laser beam from the excitation light source and which spontaneously emits light. Patent Literature 2, however, neither teaches nor suggests heat dissipation for the light-emitting section including a fluorescent substance.

Non Patent Literature 1 discloses, for example, an outline and requirement specifications of a normal headlamp, but fails to disclose a detailed arrangement of a headlamp. Non Patent Literature 1 thus fails to provide a description or suggestion about a technique for cool a light-emitting section including a fluorescent substance.

The present invention has been accomplished to solve the above problem. It is an object of the present invention to provide (i) a light-emitting device including a light-emitting section which emits light in response to excitation light and which can be cooled efficiently, (ii) an illumination device including the light-emitting device, and (iii) a vehicle headlamp including the light-emitting device. Stated differently, it is an object of the present invention to provide (i) a light-emitting device in which a temperature rise is prevented in a temperature elevation region of a light-emitting section irradiated with excitation light, and which can consequently function as a long-lifetime light source, (ii) an illumination device including the light-emitting device, and (iii) a vehicle headlamp including the light-emitting device.

### Solution to Problem

In order to solve the above problem, a light-emitting device of the present invention includes: an excitation light source for emitting excitation light; a light-emitting section for emitting light in response to the excitation light; and a cooling section for cooling the light-emitting section with use of a fluid.

According to the above arrangement, the light-emitting section emits light in response to excitation light emitted by the excitation light source. The light-emitting section during this operation generates heat as it receives the excitation light. The cooling section cools the light-emitting section with use of a fluid. Since the fluid (a gas or a liquid) can be either convected due to heat generated by the light-emitting section or artificially injected, stirred, or circulated, it is possible to replace a portion of the fluid which portion is in contact with the light-emitting section. Thus, the use of a fluid allows the light-emitting section to be cooled efficiently.

### Advantageous Effects of Invention

A light-emitting device of the present invention includes: an excitation light source for emitting excitation light; a light-emitting section for emitting light in response to the excitation light; and a cooling section for cooling the light-emitting section with use of a fluid.

As such, it is possible to cool the light-emitting section efficiently.

### BRIEF DESCRIPTION OF DRAWINGS

FIG. 1 is a cross-sectional view illustrating an arrangement of a headlamp of one embodiment of the present invention.

FIG. 2 is a view illustrating a positional relation between an emission end section and a light-emitting section of the headlamp of the one embodiment of the present invention.

FIG. 3 is a graph illustrating, with each of the lines, a temperature property of a fluorescent substance in a light-emitting section which temperature property is indicated in relation to an intensity of light emitted by the fluorescent substance in response to excitation light having a predetermined intensity.

FIG. 4 is a cross-sectional view illustrating another arrangement of the headlamp of the one embodiment of the present invention.

FIG. 5 is a cross-sectional view illustrating still another arrangement of the headlamp of the one embodiment of the present invention.

FIG. 6a is a view schematically illustrating a circuit arrangement of a laser diode.

FIG. 6b is a perspective view illustrating a basic structure of the laser diode.

FIG. 7 is a cross-sectional view illustrating an arrangement of the headlamp of the one embodiment of the present invention.

FIG. 8 is a cross-sectional view illustrating an arrangement of a headlamp of another embodiment of the present invention.

FIG. 9 is a view schematically illustrating an arrangement of a coolant circulation system.

FIG. 10 is a cross-sectional view illustrating an arrangement of the headlamp of the another embodiment of the present invention.

FIG. 11 is a view illustrating an exemplary arrangement for cooling a reflection mirror.

FIG. 12 is a view illustrating another exemplary arrangement for cooling the reflection mirror.

FIG. 13 is a cross-sectional view illustrating an arrangement of a headlamp of still another embodiment of the present invention.

FIG. 14 is a perspective view illustrating a modified example of a light guide member.

FIG. 15 is a view schematically illustrating an exterior appearance of a light-emitting unit included in a laser downlight of one embodiment of the present invention and an exterior appearance of a conventional LED downlight.

FIG. 16 is a cross-sectional view illustrating a ceiling provided with the laser downlight.

FIG. 17 is a cross-sectional view illustrating the laser downlight.

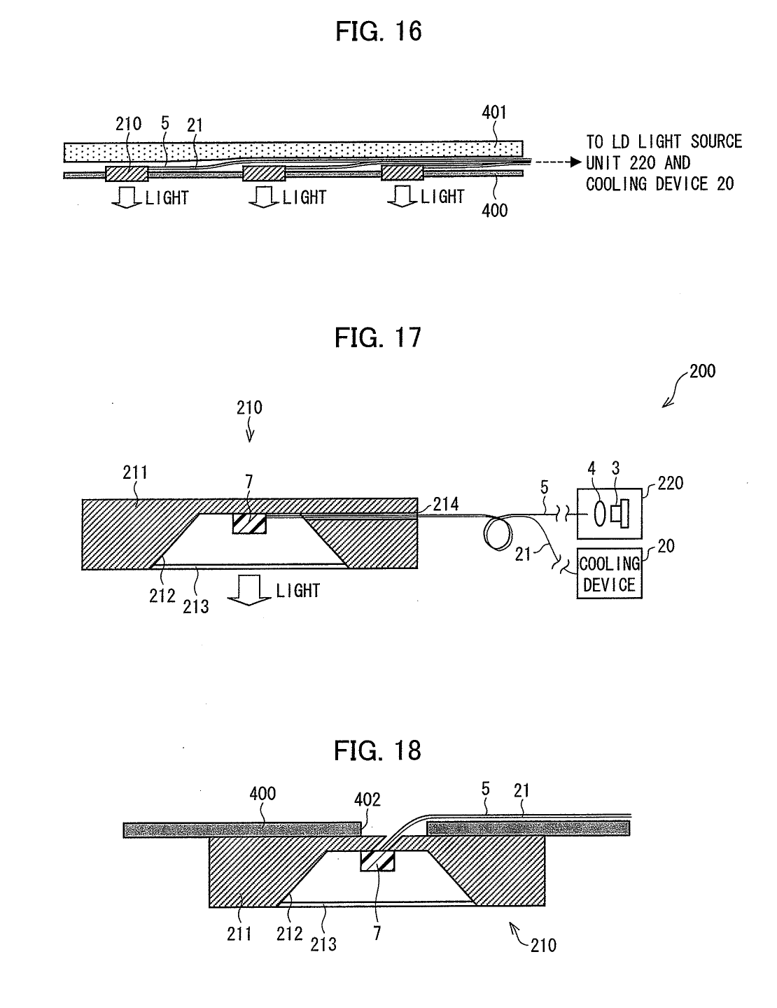

FIG. 16 is a cross-sectional view illustrating a modified example of providing of the laser downlight.

FIG. 19 is a cross-sectional view illustrating a ceiling provided with the conventional LED downlight.

FIG. 20 is a table in which specifications of the laser downlight and those of the conventional LED downlight are compared with each other.

FIG. 21 is a cross-sectional view illustrating a laser downlight of yet another embodiment of the present invention.

FIG. 22 is a cross-sectional view illustrating a ceiling provided with the conventional LED downlight.

### DESCRIPTION OF EMBODIMENTS

### Embodiment 1

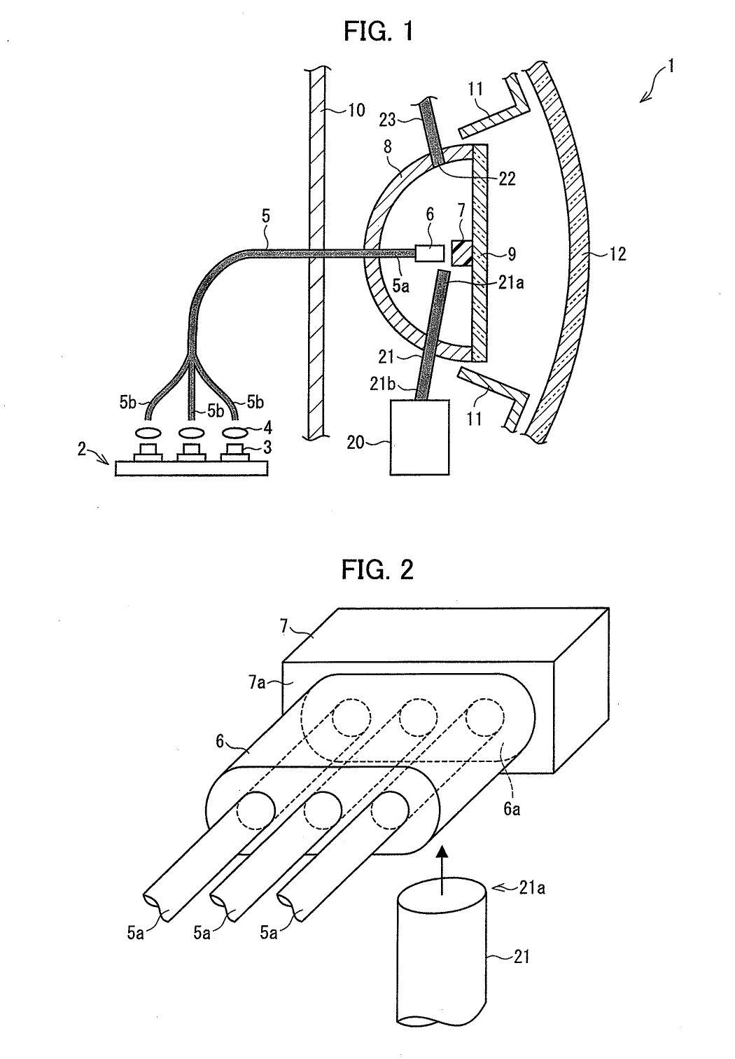

An embodiment of the present invention is described with reference to FIGS. 1 through 6. The description below deals with an automobile headlamp (vehicle headlamp) 1 as an example of an illumination device of the present invention. The illumination device of the present invention can alternatively be used as a headlamp for a vehicle or moving object other than an automobile (for example, a person, a vessel, an airplane, a submersible vessel, or a rocket). The illumination device of the present invention can further alternatively be used as another type of an illumination device such as a searchlight, a projector, or a household illumination instrument.

The headlamp 1 can meet either a light distribution property standard for a driving headlamp (high beam) or a light distribution property standard for a passing headlamp (low beam).

The description below deals with an optical fiber 5 illustrated in FIG. 1 as a bundle of a plurality of optical fibers (that is, as including a plurality of emission end sections 5a). The present invention is, however, not limited to this. The optical fiber 5 can thus include a single optical fiber (that is, include a single emission end section 5a).

(Configuration of Headlamp 1)

The following description deals first with a first configuration of the headlamp 1 with reference to FIG. 1. FIG. 1 is a cross-sectional view illustrating the first configuration of the headlamp 1. As illustrated in FIG. 1, the headlamp 1 includes: a laser diode array (excitation light source) 2; aspheric lenses 4; an optical fiber (light guide section) 5; a ferrule 6; a light-emitting section 7; a reflection mirror 8; a transparent plate (transparent member) 9; a housing 10; an extension 11; and a lens 12.

(Excitation Light Source)

The laser diode array 2 includes a plurality of laser diodes (laser diode elements) 3 on a substrate, and functions as an excitation light source for emitting excitation light. The laser diodes (excitation light source) 3 individually emit laser beams. The excitation light source not necessarily includes a plurality of laser diodes 3, and can thus alternatively include a single laser diode 3. The laser diode array 2, however, preferably includes a plurality of laser diodes 3 so as to emit a high-power laser beam.

The plurality of laser diodes 3 each include a single light-emitting point on a single chip, and are each contained in a package having a diameter of 5.6 mm. The plurality of laser diodes 3 each (i) emit a laser beam of, for example, 405 nm (blue-violet light) and (ii) have an output power of 1.0 W, an operating voltage of 5 V, and an operating current of 0.6 A. The plurality of laser diodes 3 each not necessarily emit a laser beam of 405 nm, and can thus alternatively emit any laser beam that has a peak wavelength within a range from 380 nm to 470 nm. The plurality of laser diodes 3 of the present embodiment can each alternatively be a laser diode designed to emit a laser beam having a wavelength shorter than 380 nm if it is possible to produce a laser diode for a short wavelength which laser diode (i) emits a laser beam having a wavelength shorter than 380 nm and yet (ii) has high quality.

Further alternatively, the plurality of laser diodes 3 can each include a plurality of light-emitting points on a single chip.

(Aspheric Lenses 4)

The aspheric lenses 4 each function to cause a laser beam (excitation light) emitted from a laser diode 3 to enter an end of the optical fiber 5, that is, an entrance end section 5b. The aspheric lenses 4 can each include, for example, a FLKN1 405 available from ALPS ELECTRIC Co., Ltd. The aspheric lenses 4 are each not particularly limited in shape or material, provided that the aspheric lenses 4 each include a lens having the above function. The aspheric lenses 4 are, however, preferably each made of a material which has (i) a high transmittance for a wavelength of 405 nm and its vicinity and (ii) a high heat resistance.

(Optical Fiber 5)

The optical fiber 5 includes a bundle of a plurality of optical fibers, and thus serves as a light guide member for guiding a laser beam from each laser diode 3 through to the light-emitting section 7. The optical fiber 5 includes: a plurality of entrance end sections 5b each for receiving a laser beam emitted from a laser diode 3; and a plurality of emission end sections 5a each for emitting a laser beam received by an entrance end section 5b. The plurality of emission end sections 5a emit their respective laser beams to different regions on a laser beam irradiation surface (light-receiving surface) 7a (see FIG. 2) of the light-emitting section 7. More specifically, the plurality of emission end sections 5a emit their respective laser beams to the light-emitting section 7 so that first components of the respective laser beams irradiate different regions of the laser beam irradiation surface 7a, the first components each being a component of a laser beam which component has a highest light intensity in a light intensity distribution of the laser beam.

The plurality of emission end sections 5a each emit a laser beam which spreads at a predetermined angle before it reaches the laser beam irradiation surface 7a. The plurality of emission end sections 5a emit their respective laser beams which form a plurality of irradiation regions on the laser beam irradiation surface 7a. Even if the plurality of emission end sections 5a of the optical fiber 5 are arranged on a plane parallel to the laser beam irradiation surface 7a, the irradiation regions formed by the respective laser beams from the plurality of emission end sections 5a may overlap due to the above arrangement.

Even if such overlapping occurs, the respective laser beams emitted from the plurality of emission end sections 5a to the laser beam irradiation surface 7a can be dispersed on a two-dimensional plane because the respective first components of the laser beams irradiate different regions of the laser beam irradiation surface 7a of the light-emitting section 7. A first component of a laser beam is a component which falls upon a central portion (peak portion in light intensity) of an irradiation region formed by the laser beam on the laser beam irradiation surface 7a.

The above feature can be stated differently as follows: The plurality of emission end sections 5a each emit a laser beam onto the light-emitting section 7 so that a projection image is formed by the laser beam on the laser beam irradiation surface 7a which projection image has a portion having its highest light intensity (that is, the peak portion in light intensity). With this arrangement, it is simply necessary that the peak portion in light intensity for each emission end section 5a be present at a location different from a location at which the peak portion in light intensity for any other emission end section 5a is present. As such, the irradiation regions formed by the respective laser beams emitted from the plurality of emission end sections 5a are not necessarily separated from one another completely.

The plurality of emission end sections 5a can be provided either in contact with or at a slight distance from the laser beam irradiation surface 7a. In particular, in a case where the plurality of emission end sections 5a are provided at a distance from the laser beam irradiation surface 7a, the distance is preferably set so that a laser beam emitted from each emission end section 5a and spreading in a shape of a circular cone falls in its entirely onto the laser beam irradiation surface 7a. For example, in a case where the light-emitting section 7 has a shape of a columnar so that the laser beam irradiation surface 7a has a shape of an ellipse, the plurality of emission end sections 5a are preferably positioned relative to the light-emitting section 7 so that the above distance allows the laser beam expanding in the shape of a circular cone to fall onto a region having a diameter which does not exceed a length of minor axis of the ellipse.

The plurality of optical fibers included in the optical fiber 5 each have a double-layered structure in which a center core is coated with a clad having a refractive index lower than that of the core. The core includes a quartz glass (silicon oxide) as a main component which quartz glass hardly causes an absorption loss of a laser beam. The clad includes, as a main component, either a quartz glass or a synthetic resin material each of which has a refractive index lower than that of the core. For example, the plurality of optical fibers of the optical fiber 5 are made of quartz, each include a core having a diameter of 200 μm and a clad having a diameter of 240 μm, and each have a numerical aperture NA of 0.22. The plurality of optical fibers of the optical fiber 5 are not limited in structure, thickness, or material to the above example. The plurality of optical fibers of the optical fiber 5 can, for example, each alternatively have a rectangular cross section perpendicular to its longer axis direction.

The optical fiber 5 is flexible so that the arrangement of the plurality of emission end sections 5a relative to the laser beam irradiation surface 7a can be changed easily. As such, it is possible to (i) arrange the plurality of emission end sections 5a so that their respective laser beams each irradiate a region within the laser beam irradiation surface 7a and (ii) cause the laser beams to mildly irradiate the entire laser beam irradiation surface 7a.

Since the optical fiber 5 is flexible, it is possible to easily change a positional relation between the plurality of laser diodes 3 and the light-emitting section 7. Further, adjusting a length of the optical fiber 5 allows the plurality of laser diodes 3 to be provided at a location far from a location of the light-emitting section 7.

This indicates an improved flexibility in design of the headlamp 1. For example, the plurality of laser diodes 3 can be provided at such a location as to be easily cooled or replaced. In other words, flexibility in design of the headlamp 1 can be improved because it is possible to easily change (i) a positional relation between the plurality of entrance end sections 5b and the plurality of emission end sections 5a and thus (ii) the positional relation between the plurality of laser diodes 3 and the light-emitting section 7.

The light guide member can alternatively include (i) a member other than an optical fiber or (ii) a combination of an optical fiber and another member. The light guide member is simply required to include (i) at least one entrance end section for receiving a laser beam emitted from a laser diode 3 and (ii) a plurality of emission end sections each for emitting a laser beam received by the entrance end section. For example, the light guide member can alternatively be arranged such that (i) it includes, separately from an optical fiber, an entrance section having at least one entrance end section and an emission section having a plurality of emission end sections and that (ii) the entrance section and the emission section are connected to the optical fiber at its opposite ends. The light guide member can alternatively include a single or a plurality of light guide members each of which (i) has an entrance end section and an emission end section for a laser beam and (ii) has a shape of a conical frustum or a square frustum. Further alternatively, laser beams from the plurality of laser diodes 3 can be emitted onto the light-emitting section 7 directly or with use of an optical system such as a reflection mirror.

With reference to FIG. 2, the following description deals with the positional relation between the plurality of emission end sections 5a and the light-emitting section 7. FIG. 2 is a view illustrating the positional relation between the plurality of emission end sections 5a and the light-emitting section 7.

(Ferrule 6)

As illustrated in FIG. 2, the ferrule 6 supports the plurality of emission end sections 5a of the optical fiber 5 in a predetermined pattern with respect to the laser beam irradiation surface 7a of the light-emitting section 7. The ferrule 6 can have holes in a predetermined pattern in which holes the plurality of emission end sections 5a are inserted. The ferrule 6 can alternatively be arranged such that (i) it includes an upper portion and a lower portion which are separable from each other and each of which has grooves formed on its joining surface, and that (ii) the upper portion and the lower portion sandwich the plurality of emission end sections 5a so that the plurality of emission end sections 5a are supported in respective holes formed by the grooves.

The ferrule 6 is simply required to be fixed relative to the reflection mirror 8 with use of, for example, a bar-shaped or tube-shaped member which extends from the reflection mirror 8. The ferrule 6 is not particularly limited in terms of material, and is made of stainless steel, for example. The ferrule 6 can be replaced with a plurality of ferrules 6 provided relative to a single light-emitting section 7. FIG. 1 illustrates three emission end sections 5a for convenience of explanation. The number of the plurality of emission end sections 5a is, however, not limited to three.

(Light-Emitting Section 7)

The light-emitting section 7 is provided in the vicinity of a focal point of the reflection mirror 8, and emits light in response to a laser beam emitted from an emission end section 5a. The light-emitting section 7 includes a fluorescent substance which emits light in response to a laser beam. Specifically, the light-emitting section 7 includes a fluorescent substance dispersed in silicone resin serving as a fluorescent material supporting material. The silicone resin and the fluorescent substance are present in a ratio of 10:1. The light-emitting section 7 can alternatively be made of a fluorescent substance pressed together. The fluorescent substance supporting material is not limited to silicone resin, and can thus alternatively be (i) a glass material such as an inorganic glass material or (ii) an organic or inorganic hybrid material.

The fluorescent substance is oxynitride-based, and includes blue, green, and red fluorescent substances for dispersion in silicone resin. The light-emitting section 7 emits white light in response to a 405-nm laser beam (blue-violet light) emitted from each of the plurality of laser diodes 3. The light-emitting section 7 thus functions as a wavelength converting material.

The plurality of laser diodes 3 can each alternatively serve to emit a laser beam having a wavelength of 450 nm (blue light) or a laser beam having a wavelength close to the wavelength for blue light, that is, a laser beam having a peak wavelength which falls within a range from 440 nm to 490 nm. In this case, the above fluorescent substances include (i) a yellow fluorescent substance or (ii) a mixture of a green fluorescent substance and a red fluorescent substance. In other words, the plurality of laser diodes 3 can each alternatively emit excitation light having a peak wavelength within a range from 440 nm to 490 nm. With this arrangement, it is possible to easily select and produce a material (fluorescent substance) for the light-emitting section 7 which material is used to emit white light. A yellow fluorescent substance emits light having a peak wavelength which falls within a range from 560 nm to 590 nm. A green fluorescent substance emits light having a peak wavelength which falls within a range from 510 nm to 560 nm. A red fluorescent substance emits light having a peak wavelength which falls within a range from 600 nm to 680 nm.

The above fluorescent substance can be a fluorescent substance commonly referred to as (i) a nitride fluorescent substance or (ii) an oxynitride fluorescent substance such as sialon fluorescent substance. Sialon fluorescent substance is a material in which the silicon atoms and nitrogen atoms in silicon nitride are partially substituted by aluminum atoms and oxygen atoms, respectively. Sialon fluorescent substance can be prepared by making a solid solution of, for example, silicon nitride (Si₃N⁴), alumina (Al₂O₃), silica (SiO₂), and a rare earth.

Another preferable example of the fluorescent substance is semiconductor nanoparticle fluorescent substance made of nanometer-size III-V compound semiconductor particles.

Semiconductor nanoparticle fluorescent substance has a characteristic that even in a case where they are made of a single compound semiconductor (for example, indium phosphide [InP], it is possible to change a color of emission light with use of a quantum size effect caused by changing a particle diameter of the semiconductor nanoparticle fluorescent substance to a nanometer size. For example, semiconductor nanoparticle fluorescent substance made of InP emits red light in a case where they each have a particle size (measured under a transmission electron microscope [TEM]) which falls within a range approximately from 3 nm to 4 nm.

Further, semiconductor nanoparticle fluorescent substance, since it is semiconductor-based, has a short fluorescence lifetime, and quickly emit fluorescence in correspondence with a power of excitation light. Semiconductor nanoparticle fluorescent substance thus characteristically tolerates high-power excitation light well. Semiconductor nanoparticle fluorescent substance has a light emission lifetime of approximately 10 nanoseconds, which is about 10⁻⁵ times a light emission lifetime of a normal fluorescent substance including a rare earth as a luminescent center.

Further, since semiconductor nanoparticle fluorescent substance has a short light emission lifetime as described above, they can quickly repeat a cycle of laser beam absorption and fluorescence emission. Semiconductor nanoparticle fluorescent substance consequently maintains a high fluorescence efficiency for an intense laser beam, and thus generate only a reduced amount of heat.

As such, it is possible to further prevent the light-emitting section 7 from degradation (for example, color change, deformation, and brightness decrease) caused by heat. As a result, in a case where a light-emitting device includes as a light source a light-emitting element having a high light output, it is possible to prevent the light-emitting device (a basic structure of which will be described later) from having a short lifetime.

The light-emitting section 7 has a shape of, for example, a cuboid which is 3 mm×1 mm×1 mm. In this case, the laser beam irradiation surface 7a for receiving laser beams from the plurality of laser diodes 3 is 3 mm² in area. A Japanese law stipulates a light distribution pattern (light distribution) for a vehicle headlamp which light distribution pattern is narrow in a vertical direction and wide in a horizontal direction. In a case where the light-emitting section 7 is horizontally long (substantially rectangular in a cross section), it is possible to easily achieve the above light distribution pattern. The light-emitting section 7 is not necessarily cuboid, and can thus alternatively be cylindrical so that the laser beam irradiation surface 7a has a shape of an ellipse (having a longer axis which falls within a range from, for example, 0.1 mm to 3 mm). The laser beam irradiation surface 7a is not necessarily a flat surface, and can thus alternatively be a curved surface.

The laser beam irradiation surface is, however, preferably a flat surface so as to control reflection of a laser beam. In a case where the laser beam irradiation surface is a curved surface, light falls upon the curved surface at least at greatly varying angles. Reflected light thus travels in directions which greatly vary according to a location on which a laser beam falls. As such, it may be difficult in such a case to control a reflection direction of a laser beam. In contract, in a case where the laser beam irradiation surface is a flat surface, reflected light hardly changes its traveling direction even if a slight shift is caused to a location on which a laser beam falls. As such, it is easy in such a case to control a reflection direction of a laser beam. Further, depending on circumstances, it is easy to take a measure such as providing a laser beam absorption member at a location on which reflected light falls.

The light-emitting section 7 is, as illustrated in FIG. 1, fixed on an inside surface of the transparent plate 9 (that is, a surface facing the plurality of emission end sections 5a) at such a location as to face the plurality of emission end sections 5a. How and where the light-emitting section 7 is fixed is, however, not limited to this. The light-emitting section 7 can alternatively be fixed with use of a bar-shaped or tube-shaped member which extends from the reflection mirror 8.

(Reflection Mirror 8)

The reflection mirror 8 has an opening. The reflection mirror 8 reflects light emitted from the light-emitting section 7. The reflection mirror 8 thus forms a bundle of rays traveling within a predetermined solid angle, and consequently emits the bundle of rays from the opening. In other words, the reflection mirror 8 reflects light from the light-emitting section 7 so as to form a bundle of rays traveling in a forward direction in which the headlamp 1 faces. The reflection mirror 8 is, for example, a member which has a curved surface (in a shape of a cup) and which is provided with a metal thin film on a surface thereof.

The reflection mirror 8 is not limited to a hemispherical mirror. The reflection mirror 8 can thus alternatively be an ellipsoidal mirror, a parabolic mirror, or a mirror which has an ellipsoidal or parabolic portion. In other words, the reflection mirror 8 is simply required to include, in its reflection surface, at least a portion having a curved surface formed by rotating a shape (an ellipse, a circle, or a parabola) about a rotation axis.

(Transparent Plate 9)

The transparent plate 9 is a transparent resin plate which covers the opening of the reflection mirror 8. The transparent plate 9 holds the light-emitting section 7. The transparent plate 9 is preferably made of a material which blocks laser beams from the plurality of laser diodes 3 and which transmits white light generated by conversion of the laser beams by the light-emitting section 7. The transparent plate 9 can be made of, for example, an inorganic glass plate instead of a resin plate. Although a coherent laser beam is mostly converted by the light-emitting section 7 into incoherent light, such a coherent laser beam may not entirely converted as such for a reason. Even in such a case, since the transparent plate 9 blocks laser beams, it is possible to prevent the laser beams from leaking out. The transparent plate 9 can alternatively be omitted if the above effect is unnecessary and the light-emitting section 7 is held by a member other than the transparent plate 9.

(Housing 10)

The housing 10 is a part of a body of the headlamp 1, and contains members such as the reflection mirror 8. The housing 10 is penetrated by the optical fiber 5. The above laser diode array 2 is provided outside the housing 10. The laser diode array 2, which generates heat when emitting laser beams, is provided outside the housing 10 as above so as to be cooled efficiently. Further, since a laser diode 3 may break down, the laser diode array 2 is preferably provided at such a location as to facilitate replacement of such a broken laser diode 3. The laser diode array 2 can be contained in the housing 10 if the above advantages are unnecessary.

(Extension 11)

The extension 11 is provided at a location away from the reflection mirror 8 in the forward direction so as not to overlap the opening of the reflection mirror 8. The extension 11 hides an inner structure of the headlamp 1 so as to (i) improve appearance of the headlamp 1 and (ii) improve accordance between the reflection mirror 8 and an automobile body. The extension 11 is, like the reflection mirror 8, a member provided with a metal thin film on a surface thereof.

(Lens 12)

The lens 12 is provided at an opening of the housing 10 so as to seal the headlamp 1. Light emitted from the light-emitting section 7 and reflected from the reflection mirror 8 travels through the lens 12 in the forward direction in which the headlamp 1 faces.

(Cooler 20)

The headlamp 1 includes, in addition to the above members: a cooler (a cooling section, an air blowing section) 20; a nozzle (a cooling section, an air guiding section) 21; and a nozzle 23. The reflection mirror 8 has a hole section 22 at a portion thereof. The light-emitting device of the present embodiment includes, in its basic structure, the above-described members (namely, the laser diode array 2, the optical fiber 5, the ferrule 6, and the light-emitting section 7) in addition to the cooler 20 and the nozzle 21. The cooling section includes, in its basic structure, the cooler 20 and the nozzle 21.

The cooler 20 serves to cool, with use of a fluid (gas), a temperature elevation region of the light-emitting section 7 contained in the housing 10. The temperature elevation region includes (i) an irradiation region on which a laser beam falls and (ii) a region surrounding the irradiation region. The irradiation region corresponds to a region of the laser beam irradiation surface 7a which region faces a laser beam emission surface 6a. The cooler 20 cools the temperature elevation region by, for example, blowing air directed to the temperature elevation region. The cooler 20 is, for example, an air blower having a structure of a normal electric fan. The cooler 20 in such a case includes: a shaft; a vane wheel firmly joined with the shaft; a magnet for rotating the shaft; and a driving circuit for driving the shaft. The cooler 20 thus has a structure of, for example, an electric fan disclosed in Japanese Patent Application Publication, Tokukai, No. 2009-19573 A. The shaft, the magnet, and the driving circuit together achieve a function as a normal motor.

The cooler 20 is in another arrangement an air blower having a structure of, for example, a normal air conditioner in a case where the cooler 20 serves to blow cold air for cooling the temperature elevation region. An air conditioner generates a cold wind with use of a liquid as a refrigerant (for example, liquid chlorofluorocarbon alternative) which liquid generates vaporization heat when evaporating. The cooler 20 in such a case includes members such as an evaporator, an air blowing fan, a piping system, a compressor, a condenser, a cooling fan, and a solenoid valve.

The evaporator serves to vaporize liquid chlorofluorocarbon alternative supplied from the condenser through the piping system. The evaporator includes fins made of, for example, Al. The evaporator is cooled when the liquid chlorofluorocarbon alternative absorbs vaporization heat on evaporation. The air blowing fan has a structure which is, for example, similar to the structure of the above electric fan. Specifically, the air blowing fan rotates a vane wheel firmly joined with a shaft so as to blow air to the evaporator. With this arrangement, the cooler 20 can cause air to flow into the nozzle 21 as cold air which air is present around the evaporator that has been cooled due to vaporization of the liquid chlorofluorocarbon alternative.

The piping system includes a pipe which connects the evaporator with the condenser or the compressor and which allows liquid chlorofluorocarbon alternative to pass through. The piping system serves to (i) allow liquid chlorofluorocarbon alternative to pass from the condenser to the evaporator and also (ii) allow chlorofluorocarbon alternative gas generated by the evaporator vaporizing the liquid chlorofluorocarbon alternative to pass through to the compressor.

The condenser is a housing to which chlorofluorocarbon alternative gas is supplied that has been compressed by the compressor and thus has a high temperature. The condenser includes fins made of, for example, Al. The condenser cools the high-temperature chlorofluorocarbon alternative gas with use of the cooling fan, and supplies the chlorofluorocarbon alternative gas to the solenoid valve for adjusting a pressure of the chlorofluorocarbon alternative gas. The chlorofluorocarbon alternative gas is thus liquefied. The chlorofluorocarbon alternative liquefied by the solenoid valve is supplied to the evaporator through the piping system.

The condenser, which cools high-temperature chlorofluorocarbon alternative gas with use of the cooling fan, releases hot air. In view of this, the condenser can include, in a hot air release region from which hot air is released, a nozzle (not shown) for releasing hot air to the outside of the headlamp 1. Alternatively, the cooler 20 itself can be so provided for the headlamp 1 that the condenser (or its hot air release region) is located outside the headlamp 1.

The nozzle 21 serves to cool the above-described temperature elevation region. Specifically, the nozzle 21 is a tube for supplying cold air generated by the cooler 20 to the temperature elevation region. The nozzle 21 is, for example, a cylindrical tube made of a highly transparent quartz so as to transmit a bundle of rays formed by the reflection mirror 8. The nozzle 21 has a diameter (inner diameter) of, for example, 2 mm. The nozzle 21 is, however, simply required to have a diameter which falls within a range approximately from 0.5 mm to 4 mm. In a case where the nozzle 21 is made of a metal, the nozzle 21 can also cause heat of air warmed in the temperature elevation region to dissipate in a direction of the cooler 20.

The nozzle 21 includes an inlet section 21b and an outlet section 21a. The inlet section 21b serves to receive air blown by the cooler 20. The outlet section 21a serves to release the air received by the inlet section 21b. As illustrated in FIG. 2, the outlet section 21a is provided at such a location and in such a direction that the air from the cooler 20 reaches the temperature elevation region of the laser beam irradiation surface 7a, the temperature elevation region facing the laser beam emission surface 6a of the ferrule 6. The above direction is, in other words, such that the temperature elevation region is present on an extension line of the nozzle 21 along its longer axis direction.

The above arrangement can also be described as follows: The nozzle 21 includes (i) an inlet section 21b for receiving a wind generated by the cooler 20 and (ii) an outlet section 21a for releasing the wind received by the inlet section 21b, the outlet section 21a being provided in the vicinity of the temperature elevation region. This arrangement allows the headlamp 1 to cause a wind generated by the cooler 20 to reach the temperature elevation region and consequently allows the wind to cool the temperature elevation region.

The nozzle 21 in FIG. 2 has a linear shape (bar shape), but is not limited to this in terms of shape. The nozzle 21 can alternatively be a tube which is, like the optical fiber 5, flexible and can thus change its shape (that is, can be curved).

In a case where the nozzle 21 is flexible, it is possible to easily change a positional relation between the cooler 20 and the light-emitting section 7. Further, adjusting a length of the nozzle 21 allows the cooler 20 to be provided at a location far from the light-emitting section 7. In this case, the cooler 20 is not necessarily contained in the housing 10 as in FIG. 2. The cooler 20 can be provided, like the optical fiber 5, outside the housing 10 with the nozzle 21 penetrating the housing 10.

With the above arrangement, (i) the cooler 20 can be provided at such a location as to facilitate, in a case where the cooler 20 is broken, easy repair or replacement of the cooler 20, and (ii) flexibility in design of the headlamp 1 is improved as a result.

The hole section 22 is formed at a portion of the reflection mirror 8 in a number of at least one (1). The hole section 22 serves to prevent a wind (air) which has reached the temperature elevation region from remaining in a space defined by the reflection mirror 8 and the transparent plate 9. In other words, the hole section 22 serves to allow air warmed in the temperature elevation region to escape from the space. The hole section 22 has a diameter of, for example, 3 mm. The hole section 22 is, however, simply required to have a diameter which falls within a range approximately from 1 mm to 5 mm.

The above arrangement can also be described as follows: The light-emitting section 7 is provided in a space defined by the reflection mirror 8 and the transparent plate 9. The reflection mirror 8 has a curved surface, and has an opening which faces in a direction in which a bundle of rays travels. The transparent plate 9 covers the opening of the reflection mirror 8, and transmits the bundle of rays. Further, the reflection mirror 8 has at least one hole section for releasing air remaining in the space. This arrangement allows air warmed in the temperature elevation region to escape through the hole section 22 and thus prevents such air from remaining in the space. This arrangement consequently reduces the possibility of the headlamp 1 suffering from a decrease in the effect of cooling the temperature elevation region.

The hole section 22 can be formed at any location in the reflection mirror 8. However, the hole section 22 is preferably formed at, for example, a location which a wind released from the outlet section 21a reaches after reaching the temperature elevation region of the laser beam irradiation surface 7a. The hole section 22 is formed, for example, at such a location and in such a direction that symmetry is achieved with respect to the longer axis of the optical fiber 5 between the hole section 22 and the nozzle 21 penetrating the reflection mirror 8.

The nozzle 23 is a tube inserted in the hole section 22 so as to release, to the outside of the space, air flowing into the hole section 22 from the space. The nozzle 23 is, for example, a cylindrical tube made of Teflon (registered trademark) resin or silicone resin, and has an outer diameter of 3 mm. The nozzle 23 is, however, simply required to have an outer diameter which falls within a range approximately from 1 mm to 5 mm. The nozzle 23 has an inner diameter of 2 mm. The nozzle 23 is, however, simply required to have an inner diameter which falls within a range approximately from 0.5 mm to 4 mm.

The nozzle 23 can be provided with an air sucker at its outlet end section. The air sucker serves to suck air that has flown into the nozzle 23. The outlet end section is an end section which is opposite to an end section inserted in the hole section 22 and which releases the air that has flown into the nozzle 23.

The outlet end section of the nozzle 23 can be provided at such a location as to allow air to be released toward a surface of the lens 12. This surface of the lens 12 can be either (i) a first surface facing the transparent plate 9, that is, a surface facing the inside of the headlamp 1, or (ii) a second surface opposite to the first surface. In a case where the nozzle 23 is provided with an air sucker at its outlet end section, the air sucker can be arranged such that (i) it is provided with a nozzle which is separate from the nozzle 23 and which has its outlet end section, and that (ii) the outlet end section of this separate nozzle is provided at such a location as to allow air to be released toward the surface of the lens 12. In this case, the headlamp 1 can not only release air warmed in the temperature elevation region to the outside of the space, but also prevent the surface of the lens 12 from freezing.

As described above, the headlamp 1 of the present embodiment includes: laser diodes 3 each for emitting a laser beam; an optical fiber 5 including (i) entrance end sections 5b each for receiving a laser beam emitted from a laser diode 3 and (ii) emission end sections 5a each for emitting a laser beam received by an entrance end section 5b; a light-emitting section 7 for emitting light in response to a laser beam emitted from the emission end section 5a; and a cooler 20 and a nozzle 21 for cooling a temperature elevation region of the light-emitting section 7 which temperature elevation region includes (i) an irradiation region on which a laser beam falls and (ii) a region surrounding the irradiation region.

The inventor of the present invention has found a problem that if a light-emitting section is excited by a high-power laser beam having a high power density, the light-emitting section is degraded significantly. This problem will occur even in a case where light emitted from an LED is used as excitation light as long as the excitation light has a high power. The degradation of a light-emitting section is caused primarily by (i) degradation of fluorescent substance itself included in the light-emitting section and (ii) degradation of a material (for example, silicone resin) containing the fluorescent substance. The above-mentioned nitride fluorescent substance and oxynitride fluorescent substance each emit light in response to a laser beam at an efficiency ranging from 60% to 90%, while the rest of the energy is unfortunately used in a form of released heat. This heat presumably causes degradation of the material containing the fluorescent substance.

To solve this problem, the headlamp 1 has the above-described arrangement. The headlamp 1 thus prevents a temperature rise in the temperature elevation region so as to provide a long-lifetime light source. In other words, the headlamp 1 can serve as a highly reliable, high-luminance light source.

(Emission Intensity of Light-Emitting Section)

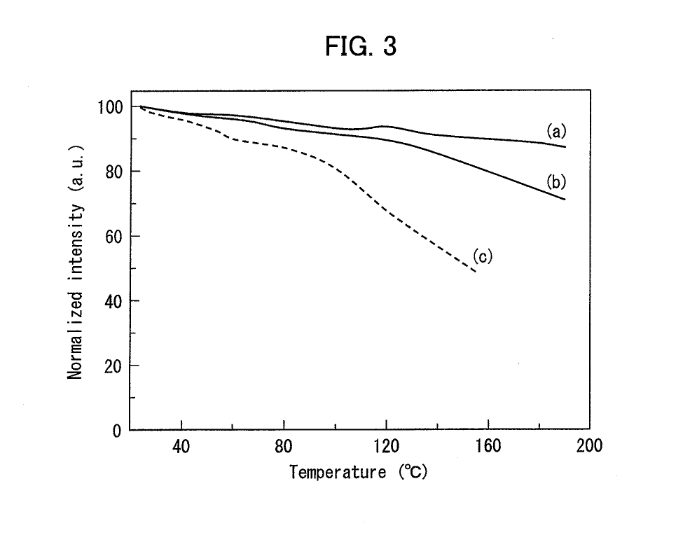

The following description deals with an emission intensity of a light-emitting section with reference to FIG. 3. FIG. 3 is a graph illustrating, with each of the lines, a temperature property of fluorescent substance in a light-emitting section which temperature property is indicated in relation to an intensity of light emitted by the fluorescent substance in response to excitation light having a predetermined intensity. In FIG. 3, (a) indicates a temperature property of nitride fluorescent substance A represented by chemical formula Ca_{0.98}Eu_{0.02}AlSiN₃; (b) indicates a temperature property of nitride fluorescent substance B represented by chemical formula Ca_{0.95}Eu_{0.05}AlSiN₃; and (c) indicates a temperature property of YAG:Ce³⁺ fluorescent substance (available from Kasei Optonix Ltd.; product number P46-Y3), in which cerium Ce³⁺ has been introduced into yttrium aluminate (Y₃Al₅O₁₂: YAG) as an activator. The graph of FIG. 3 plots “Normalized Intensity (a.u.)” in ordinate and “Temperature (° C.)” in abscissa.

As indicated by (c) in FIG. 3, a light-emitting section including YAG:Ce³⁺ fluorescent substance has, at approximately 150° C., an emission intensity which is approximately 60% of an emission intensity achieved by this light-emitting section at room temperature (30° C.). In contrast, as indicated by (a) in FIG. 3, a light-emitting section including the nitride fluorescent substance A has, at approximately 150° C., an emission intensity which is approximately 90% of an emission intensity achieved by this light-emitting section at room temperature (30° C.). Further, as indicated by (b) in FIG. 3, a light-emitting section including the nitride fluorescent substance B has, at approximately 150° C., an emission intensity which is approximately 83% of an emission intensity achieved by this light-emitting section at room temperature (30° C.). This indicates that it is preferable to use nitride fluorescent substance or oxynitride fluorescent substance as a fluorescent substance in a light-emitting section since (i) nitride fluorescent substance exhibits only a small decrease in emission intensity in response to a temperature rise caused by excitation light irradiation and (ii) oxynitride fluorescent substance is highly similar to nitride fluorescent substance in temperature property.

Even in the case where a light-emitting section includes nitride fluorescent substance, the light-emitting section unfortunately has a decrease in emission intensity (luminous efficiency) due to a temperature rise as indicated in FIG. 3. In particular, since laser beams used as excitation light in the present embodiment each have a high intensity (in watt) and a high power density (in watt/mm²), the light-emitting section 7 including sialon fluorescent substance has a significant temperature rise. This indicates that even the light-emitting section 7 may have a decrease in luminous efficiency due to such a significant temperature rise and consequently suffer from degradation.

To solve this problem, the headlamp 1 of the present embodiment uses the cooler 20 and the nozzle 21 for cooling the temperature elevation region of the light-emitting section 7 so as to prevent a temperature rise in the light-emitting section 7. This arrangement prevents a decrease in luminous efficiency of the nitride fluorescent substance or the oxynitride fluorescent substance so as to consequently prevent degradation of the light-emitting section 7.

(Another Configuration of Headlamp 1)

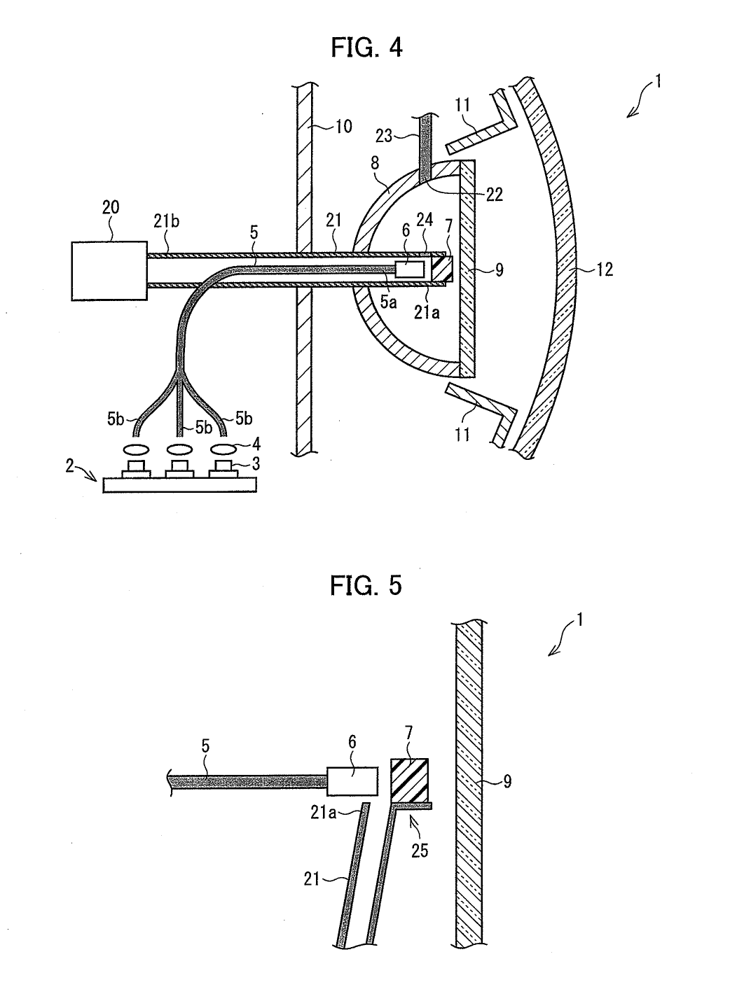

The following description deals with a second configuration of the headlamp 1 with reference to FIG. 4. FIG. 4 is a cross-sectional view illustrating the second configuration of the headlamp 1. Constituents of the headlamp 1 having the second configuration that are identical to their equivalents included in the headlamp 1 of FIG. 1 are not described here since they are described above.

In the headlamp 1 of FIG. 4, the light-emitting section 7 is fixed on an end of a tubular member which extends so as to penetrate a central portion of the reflection mirror 8. This tubular member is a nozzle 21 having a function of carrying a wind from the cooler 20 to the temperature elevation region. The nozzle 21 includes an outlet section 21a, which supports the light-emitting section 7.

The plurality of emission end sections 5a included in the optical fiber 5 can be provided inside the nozzle 21 as illustrated in FIG. 4. In other words, the optical fiber 5 and the nozzle 21 can be coaxially provided. In this case, the nozzle 21 has a hole section which allows the optical fiber 5 extending from the vicinity of the plurality of laser diodes 3 to be inserted the nozzle 21.

Stated differently, the headlamp 1 of FIG. 4 is arranged such that the nozzle 21 contains at least the plurality of emission end sections 5a of the optical fiber 5. This arrangement, as compared to the arrangement in which the optical fiber 5 and the nozzle 21 are provided separately, not only reduces a space required but also makes it possible to simply create a design which takes into consideration, for example, (i) a length and orientation of the nozzle 21 and (ii) a distance between the outlet section 21a and the laser beam irradiation surface 7a.

The nozzle 21 can have at least one hole section 24 at a portion in the vicinity of the laser beam irradiation surface 7a. The hole section 24 serves to allow air to escape from the inside of the nozzle 21 which air has reached the laser beam irradiation surface 7a and thus warmed by the temperature elevation region. The hole section 24 has a shape of a circle having a diameter of, for example, 2 mm. The hole section 24 is, however, simply required to have a diameter which falls within a range approximately from 1 mm to 3 mm. The hole section 24 can alternatively have a shape of a rectangle which is 1 mm×3 mm. The hole section 24 is simply required to be (i) capable of allowing air warmed by the temperature elevation region to efficiently escape to the outside of the nozzle 21 and (ii) strong enough to support the light-emitting section 7.

The hole section 22 is simply required to be formed at such a suitable location as to prevent air from remaining in the space defined by the reflection mirror 8 and the transparent plate 9 which air has been warmed by the temperature elevation region and released from the hole section 24. In this case, the hole section 22 is simply required to be provided at, for example, such a location that respective centers of the hole sections 22 and 24 can be directly connected to each other with a straight line.

With reference to FIG. 5, the following description deals with another manner in which the outlet section 21a of the nozzle 21 supports the light-emitting section 7. FIG. 5 is a cross-sectional view illustrating a third configuration of the headlamp 1.

As illustrated in FIG. 5, the nozzle 21 (specifically, the outlet section 21a) includes at an end thereof a protruding section 25 serving as a supporting member which supports the light-emitting section 7 by firmly joining with it. The protruding section 25 is simply required to have a size and a shape which allow the light-emitting section 7 to firmly join with the protruding section 25. The protruding section 25 can thus, for example, be a single plate-shaped (fan-shaped) member or a plurality of bar-shaped members. The protruding section 25 can be (i) molded so as to protrude from the nozzle 21, or (ii) provided as a member which is separate from the nozzle 21 and which is combined with the nozzle 21.

As described above, in each of the headlamps 1 of FIGS. 4 and 5, the light-emitting section 7 is supported by the outlet section 21a. This arrangement allows the nozzle 21 of each headlamp 1 to be used effectively, that is, not only to carry a wind generated by the cooler 20 to the temperature elevation region, but also as a supporting member for the light-emitting section 7. In other words, in each of the headlamps 1 of FIGS. 4 and 5, it is possible to efficiently use the nozzle 21 provided so as to cool the temperature elevation region.

(Another Configuration of Cooler 20)

The above description describes the cooler 20 as serving to blow air toward the temperature elevation region. The cooler 20 is, however, not limited to this in arrangement. The cooler 20 can thus alternatively be, for example, an air sucker for sucking, through the nozzle 21, air present near the temperature elevation region. With this arrangement, neither of the hole section 22 and the nozzle 23 needs to be provided. The cooler 20, in a case where it is an air sucker, has a configuration suitable for sucking air, for example, a configuration including a Sirocco fan.

The cooler 20 can be provided with a nozzle separate from the nozzle 21 which nozzle has its outlet end section provided at such a location as to blow air toward a surface of the lens 12. This configuration allows air present near the temperature elevation region to be at least released to the outside of the cooler 20. With this configuration, the headlamp 1 can not only release air warmed in the temperature elevation region to the outside of the space defined by the reflection mirror 8 and the transparent plate 9, but also prevent the surface of the lens 12 from freezing.

Even with this arrangement, the headlamp 1 prevents a temperature rise in the temperature elevation region so as to provide a long-lifetime light source. In other words, the headlamp 1 can serve as a highly reliable, high-luminance light source.

The cooler 20 can alternatively further function as a cooling device for cooling a particular member of the automobile.

The cooler 20 can be arranged to operate (for example, generate a wind) only when the plurality of laser diodes 3 are emitting laser beams. Further, the cooler 20 can also be arranged to operate only when (i) intensity of laser beams emitted to the light-emitting section 7 has a predetermined value or above, or when (ii) temperature of the temperature elevation region has a predetermined value or above. In a case where the headlamp 1 is designed so that a wind caused by driving the automobile is guided to the light-emitting section 7, the cooler 20 can be turned on and off in accordance with a speed of the automobile.

(Configuration of Laser Diode 3)

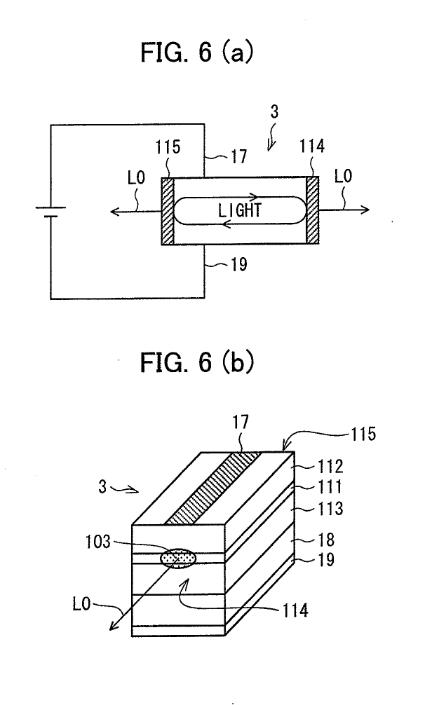

The following description deals with a basic structure of a laser diode 3. FIG. 6(a) is a diagram schematically illustrating a circuit of the laser diode 3. FIG. 6(b) is a perspective view illustrating the basic structure of the laser diode 3. As illustrated in FIG. 6(b), the laser diode 3 includes: a cathode electrode 19; a substrate 18; a clad layer 113; an active layer 111; a clad layer 112; and an anode electrode 17. These members are stacked on one another in that order.

The substrate 18 is a semiconductor substrate. The substrate 18 is preferably made of GaN, sapphire, or SiC so that the laser diode 3 can, as in the present invention, emit excitation light within blue to ultraviolet ranges for exciting fluorescent substance. A substrate for use in a laser diode is typically made of, other than the above examples, any one of (i) IV semiconductors such as Si, Ge, and SiC, (ii) III-V compound semiconductors such as GaAs, GaP, InP, AlAs, GaN, InN, InSb, GaSb, and AlN, (iii) II-VI compound semiconductors such as ZnTe, ZeSe, ZnS, and ZnO, (iv) oxide insulators such as ZnO, Al₂O₃, SiO₂, TiO₂, CrO₂, and CeO₂, and (v) nitride insulators such as SiN.

The anode electrode 17 serves to supply a current to the active layer 111 via the clad layer 112.

The cathode electrode 19 is provided below the substrate 18, and serves to supply a current to the active layer 111 via the clad layer 113. The active layer 111 is supplied with a current as such in response to a forward bias voltage applied between the anode electrode 17 and the cathode electrode 19.

The active layer 111 is sandwiched between the clad layers 112 and 113.

The active layer 111 and the clad layers 112 and 113 are each made of a mixed crystal semiconductor (AlInGaN) so that the laser diode 3 can emit excitation light within the blue to ultraviolet ranges. The active layer 111 and the clad layers 112 and 113 can each alternatively be made of a typical material for an active layer and a clad layer of a laser diode which typical material is a mixed crystal semiconductor primarily constituted by any combination of Al, Ga, In, As, P, N, and Sb. The active layer 111 and the clad layers 112 and 113 can each further alternatively be made of Zn, Mg, S, Se, or Te, or a II-VI compound semiconductor such as ZnO.

The active layer 111 is a region which emits light in response to a supplied current. The light is confined in the active layer 111 due to a difference in refractive index between the clad layers 112 and 113.

The active layer 111 has a front cleaved surface 114 and a rear cleaved surface 115 facing each other so as to confine light amplified by stimulated emission. The front and rear cleaved surfaces 114 and 115 each serve as a mirror.

More specifically, the front and rear cleaved surfaces 114 and 115 each serve not as a mirror which totally reflects light: The light amplified by stimulated emission is partially emitted from the front cleaved surface 114 and the rear cleaved surface 115 of the active layer 111 (only from the front cleaved surface 114 in the present embodiment for convenience of explanation) so as to provide excitation light L0. Further, the active layer 111 can have a multilayer quantum well structure.

The rear cleaved surface 115 facing the front cleaved surface 114 is provided with a reflection film (not shown) for laser oscillation. Respective reflectances of the front and rear cleaved surfaces 114 and 115 are thus made different from each other so that most of the excitation light L0 is emitted from a low-reflectance end surface (for example, the front cleaved surface 114), specifically from a light-emitting point 103.

The clad layers 112 and 113 are each made of either of (i) a III-V compound semiconductor (for example, GaAs, GaP, InP, AlAs, GaN, InN, InSb, GaSb, or AlN) of an n-type or p-type, and (ii) a II-VI compound semiconductor (for example, ZnTe, ZeSe, ZnS, and ZnO) of an n-type or p-type. With this arrangement, it is possible to supply a current to the active layer 111 by applying a forward bias voltage between the anode electrode 17 and the cathode electrode 19.

The semiconductor layers such as the clad layers 112 and 113 and the active layer 111 can each be deposited by a typical film deposition method such as MOCVD (metal-organic chemical vapor deposition), MBE (molecular-beam epitaxy), CVD (chemical vapor deposition), laser ablation, and sputtering. The metal layers can also be deposited by a typical film deposition method such as vacuum deposition, plating, laser ablation, and sputtering.

(Principle of Light Emission of Light-Emitting Section 7)

The following description deals with a principle on which the fluorescent substance emits light in response to a laser beam emitted from a laser diode 3.

First, a laser diode 3 emits a laser beam which then falls on the fluorescent substance included in the light-emitting section 7. The laser beam excites low-energy electrons present in the fluorescent substance so that they are in a high-energy state (excited state).

Then, since the excited state is unstable, the energy state of the electrons in the fluorescent substance returns to the original low-energy state after a certain period of time. The low-energy state refers to a ground-level energy state or a metastable-level energy state between the excitation level and the ground level.

The fluorescent substance emits light as the high-energy state of the excited electrons returns to the low-energy state as described above.

White light can be generated from (i) a mixture of three colors which meet an isochromatic principle or (ii) a mixture of two colors which meet a complimentary relation with each other. Specifically, white light can be generated from combining, on the basis of the principle and relation, (i) a color of a laser beam emitted from the laser diode and (ii) a color of light emitted from the fluorescent substance.

In a case where 10 of the above-described laser diode 3 are provided and each laser diode 3 emits a laser beam of 405 nm, the light-emitting section 7 emits light having a luminous flux of 1500 μm and a luminance of 80 cd/mm².

### Embodiment 2

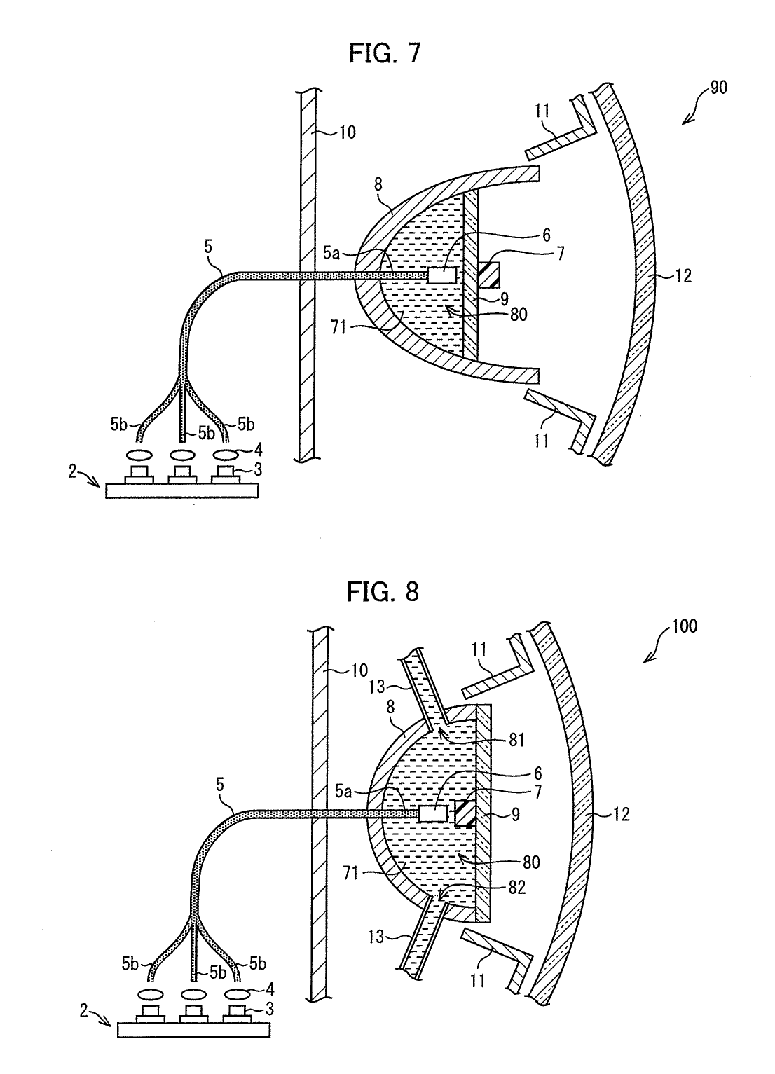

The following description discusses another embodiment of the present invention with reference to FIG. 7. Note that a member same as the member discussed in Embodiment 1 is given a same reference numeral, and description thereof is omitted.

(Configuration of Headlamp 90)

FIG. 7 is a cross-sectional view showing how a headlamp 90 is configured. As shown in FIG. 7, the headlamp includes: a laser array (excitation light source) 2; aspheric lenses 4; an optical fiber (light guide section) 5; a ferrule (retentive member) 6; a light-emitting section 7; a reflection mirror 8; a transparent plate (light-transmitting section) 9; a housing 10; an extension 11; and a lens 12. A fundamental structure of a light-emitting device is made up of the laser array 2, the optical fiber 5, the light-emitting section 7, and the reflection mirror 8.

(Light-Emitting Section 7)

It is preferable that a laser beam be emitted toward the light-emitting section 7 at a light output of 1 W or greater but 30 W or smaller, and condensed on a laser irradiation surface of the light-emitting device 7 at a light density (irradiation density) of 1 W mm² or greater but 1 KW mm² or smaller. A light beam with its light output and irradiation density within the respective ranges can be emitted as illumination light which is satisfactory as a headlamp. Further, use of such a laser beam can prevent it from occurring that the light-emitting section 7 is greatly deteriorated by a laser beam of a high output.

On irradiation with a laser beam of such a light output or such an irradiation density, the light-emitting section 7 causes great heat generation. Thus, in order for the light-emitting section 7 not to be deteriorated, it is preferable that the light-emitting section 7 be cooled.

In a case of using a resin material as a sealing material of the light-emitting section 7, it is preferable to select a resin material having a high barrier property against a fluid component.

As shown in FIG. 7, the light-emitting section 7 is provided on an outer side of the transparent plate 9 (which is a side opposite to a side on which the ferrule 6 is provided), so as to be located approximately at a focal point of the reflection mirror 8 and face the emission end section 5a. According to the configuration, a laser beam emitted from the emission end section 5a irradiates the light-emitting section 7 via the transparent plate 9.

A thickness of a layer between the laser beam irradiation surface of the light-emitting section 7 and the light-emitting surface facing thereto may or may not be 1 mm. The thickness of this layer is not limited to a particular one, provided that the light-emitting section 7 has a thickness thick enough to allow the incident laser beam to be (i) converted to white light and scattered so sufficiently that the incident laser beam of a very small emission spot size, which is harmful to a human body, particularly to eyes, is expanded so as to have a sufficiently large emission spot size.

A required thickness of the light-emitting section 7 is varied in accordance with a ratio of a fluorescent substance supporting material of the light-emitting section 7 to a fluorescent substance thereof. The more the fluorescent substance is contained in the light-emitting section 7 is, the higher a conversion efficiency of the laser light to the white light becomes. Thus, an increase in a content of the fluorescent substance in the light-emitting-section 7 allows a reduction in thickness of the light-emitting section 7.

(Transparent Plate 9)

The transparent plate 9 is attached to the reflection mirror 8. Fluorescent light emitted from the light-emitting section 7 is reflected by the reflection mirror 8 so as to form a laser beam, and the laser beam thus formed is transmitted through the transparent plate 9 toward a front direction. As early described, the light-emitting device 7 is adhered to a surface of the outward side of the transparent plate 9. The reflection mirror 8 and the transparent plate 9 constitute at least a part of a coolant reservoir in which a coolant for cooling the light-emitting section 7 is reserved.

(Principle of Cooling)

A coolant 71 (fluid) is stored in a space 80 defined by the reflection mirror 8 and the transparent plate 9. When the light-emitting section 7 generates heat, the coolant 71 is heated, near the light-emitting section 7, by the heat conducting from the light-emitting section 7. A heated portion of the coolant 71 rises, whereas an unheated portion of the coolant 71 moves closer to the light-emitting section 7. Generation of such a convection phenomenon in the coolant 71 allows efficient cooling of the light-emitting device 7. It is thought that a heat quantity of the entire coolant 71 is kept being increased while the light-emitting section 7 is generating heat. In such a circumstance, it is preferable to cool the coolant 71, as later described.

The coolant 71 may be purified water. However, it is preferable that the coolant 71 be a solution containing a variety of additives, so that (i) a boiling temperature of the coolant 71 can be higher than that of water, (ii) a heat conductivity of the coolant 71 can be greater than that of the water, (iii) metal decay can be prevented, and/or (iv) freezing of the coolant 71 due to a low temperature can be prevented. The additives can be ethylene glycol, propylene glycol, an antifoam agent for preventing generation of a foam which deteriorates a cooling capability. Instead of the solution containing any of the additives (i) through (iii), a clear oil may be used as the coolant 71.

Note, however, that it is preferable that the coolant 71 is basically clear and colorless. This is because if clearness of the coolant 71 is low, there will be a decrease in an emission efficiency that fluorescent light emitted from the light-emitting section 7 is emitted outside the headlamp 90. On the other hand, if the coolant 71 is colored, there will be a possibility that a color of illumination light of the headlamp 90 is not white as stipulated under Japanese laws.

Paradoxically speaking, in a case of employing the illumination device of the present invention as a light other than a headlamp, it is possible to intentionally color the coolant 71 by a desired color. This can set up a color of illumination light.

(Effect of Headlamp 90)

The inventors of the present invention found that a light-emitting section is greatly degraded (i.e., suffers property fluctuation and/or a reduction in lifetime) if excited with a laser beam of high power or a laser beam of high density. It is thought that this is true even for a case where the light-emitting section is excited with light emitted from an LED, if the light emitted from the LED is of high power and high density. Degradation of the light-emitting section is mainly caused by degradation of fluorescent substance contained in the light-emitting section and degradation of a sealing material encircling the fluorescent substance. The nitride fluorescent substance and the oxynitride fluorescent substance early described generate light with respective generation efficiencies of 60% to 90% when irradiated with a laser beam. A rest of an energy of the laser beam, which is not used in generation of the light, is emitted as heat. It is thought that the heat thus emitted cause the degradations of the fluorescent substance and the sealing material encircling the same.

The headlamp 90 is configured so that the light-emitting sections 7 are cooled by the coolant 71 filling the inside of the reflection mirror 8. This allows efficient cooling of the light-emitting sections 7 that are heatable by irradiation of a laser beam. Thus, the light-emitting sections 7 can be prevented from being deteriorated. In this case, it is possible to prevent the deterioration of the light-emitting sections 7 without decreasing a light beam emitted from the light-emitting surfaces 7. It is therefore possible to make the headlamp 90 which is superior in view of lifetime and reliability while a brightness required as a headlamp is obtained.

Further, since the lifetime of the light-emitting sections 7 is improved, it is possible to reduce work and cost of change the light-emitting sections 7.

A refractive index of the clear fluid, such as water, is greater than that of air. For example, a refractive index of water is approximately 1.33, and a refractive index of ethanol is approximately 1.36. By filling an inward side of the reflection mirror 8, on which inward side the light-emitting section 7 is provided, with such a material having a refractive index greater than that of the air, it is possible to increase a light ray directed toward the reflection mirror 8. An emission direction of the light serving as illumination light can be controlled only by controlling the light ray directed toward the reflection mirror 8. By increasing the light ray directed toward the reflection mirror 8, it is possible to increase light which can be used as the illumination light. Thus, by filling the inward side of the reflection mirror 8 with the material having the refractive index greater than that of the air, it is possible to improve a light use efficiency as compared to a case where the inward side of the reflection mirror 8 is filled with the air.

Since even the laser diode 3 generates heat, it is preferable to cool it by air-cooling or the like. Use of the optical fiber 5 as a light guide member can improve flexibility in design of the headlamp 90. For example, it is possible to provide the laser diode 3 at such a location that cooling or changing of the laser diode 3 can be easily carried out. It is possible to use a single device as a device for cooling the laser diode 3 and a device for cooling the coolant 71.

The present invention can realize a high-luminance light source, and this naturally allows miniaturization of the reflection mirror 8. This brings about a merit that a filling amount of the coolant 71 can be reduced.

(Modified Example)

The excitation light source of the headlamp 90 may be a laser diode in which a single chip have a plurality of emission points. For example, the single chip of the laser diode may have five (5) emission points.

In a case where a laser diode is used, a rod-shaped lens is provided so as to face that surface of the laser diode which has emission points. The rod-shaped lens directs, onto an entrance end section of the optical fiber 5, a laser beam emitted from each of the emission points. Instead of the rod-shaped lens, aspheric lenses 4 may be provided for each of the emission points. However, the use of the rod-shaped lens simplifies the arrangement of the laser diode.

### Embodiment 3

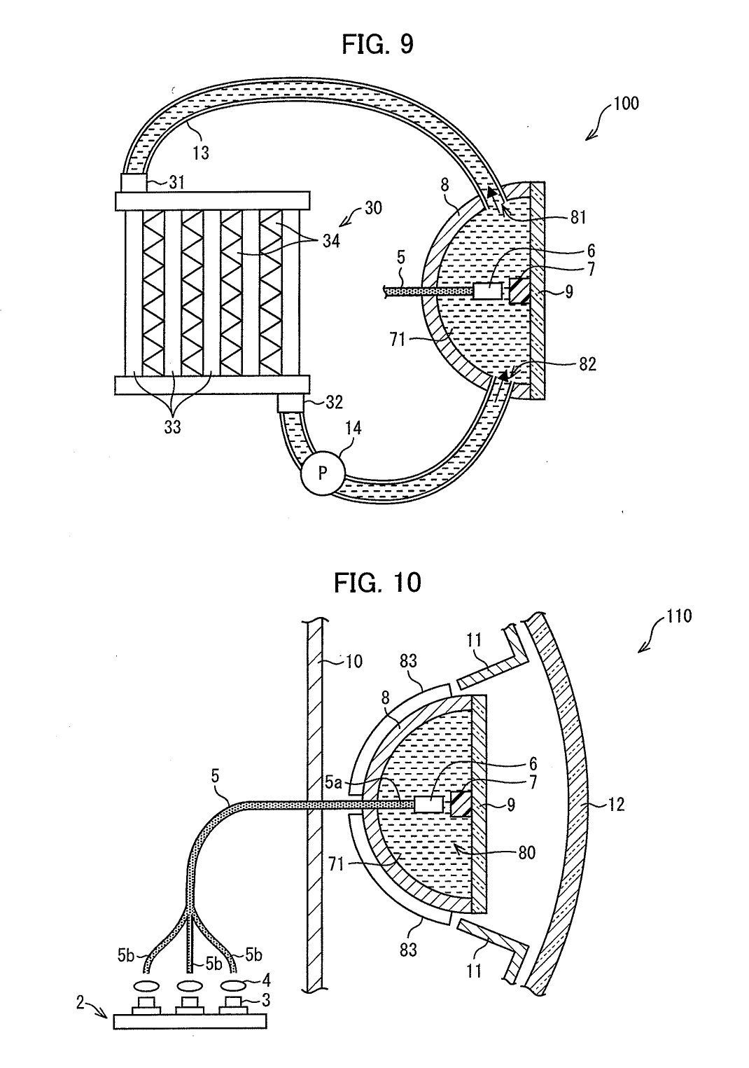

Still another embodiment of the present invention is described below with reference to FIGS. 8 and 9. Note that a member same with the member discussed in Embodiments 1 and 2 is given a same reference numeral, and description thereof is omitted.

(Configuration of Headlamp 100)

FIG. 8 is a cross-sectional view showing how a headlamp 100 is configured in accordance with the present embodiment. As shown in FIG. 8, the headlamp 100 has a cooling system in which a coolant 71 is circulated.

(Light-Emitting Section 7)

According to the present embodiment, the light-emitting section 7 is provided on an inward side of a transparent plate 9 (which is a side on which an emission end section 5a is provided), so as to be fixed to a location (i) which is approximately a focal point of a reflection mirror 8 and (ii) where the light-emitting section 7 faces an emission end section 5a. Note that the light-emitting section 7 can be fixed by a rod-like or tubular member extending from the reflection mirror 8. A laser beam emitted from the emission end section 5a directly (i.e., without passing through the transparent plate 9) irradiates the light-emitting section 7.

(Reflection Mirror 8)

The reflection mirror 8 is substantially same as the reflection mirror 8 included in the headlamp 1, while being different from it in terms that a discharge opening 81 and an inflow opening 82 are provided. The coolant 71 flows in through the inflow opening 82 and is discharged through the discharge opening 81. A tube 13 is connected to the discharge opening 81 and the inflow opening 82, and allows circulation of the coolant 71.

(Transparent Plate 9)

The transparent plate 9 is a transparent resin plate which covers the opening of the reflection mirror 8. The transparent plate 9 holds the light-emitting section 7. The reflection mirror 8 and the transparent plate 9 constitute at least a part of a coolant reservoir in which a coolant for cooling the light-emitting section 7 is reserved. The coolant 71 is reserved in the coolant reservoir in such a way that the coolant 71 is in contact with at least part of the light-emitting section 7.

(Circulation System of Coolant 71)

FIG. 9 is a view schematically illustrating an arrangement of a circulation system for circulating the coolant 71. Tubes 13 are connected to respective of the discharge opening 81 and the inflow opening 82 which are provided in the reflection mirror 8. A circulation path for the coolant 71, which is constituted by the tube 13 that extends from the discharge opening 82, is eventually in communication with the inflow opening 82. The coolant 71 is sent, by a drive power of a small pump 14, to the radiator 30 via the tube 13. The coolant 71 thus sent is cooled by the radiator 30, and then sent back to the space 80.

The tube 13 is not limited to a particular one, provided that it constitutes a circulation path via which the coolant 71 flows. However, in view of easiness of providing of a headlamp 100, it is preferable that the tube 13 has a flexibility.

The discharge opening 81 is provided above the light-emitting section 7 with respect to a vertical direction of the reflection mirror 8, and the inflow opening 82 is provided below the light-emitting section 7 with respect to the vertical direction of the reflection mirror 8. The arrangement allows such an efficient discharge that the heated portion of the coolant 71, which is heated and thereby rises with respect to the vertical direction of the reflection mirror 8, is discharged via the discharge opening 81.

A pump 14 allows such circulation of the coolant 71 that the coolant 71, which has been discharged through the discharge opening 81, flows back into the space 80 through the inflow opening 82. As such, it can be said that the pump 14 is a circulation device which generates a flow of the coolant 71 in the circulation path. The pump 14 is not limited to any device, provided that is allows circulation of the coolant 71.

The radiator device 30 is a cooling device provided for cooling the coolant 71. The radiator 30 has an inflow opening 31 and an outflow opening 32. The coolant 71 flows into the radiator 30 via the inflow opening 31 and is discharged from the radiator 30 via the outflow opening 32. The radiator 30 includes a plurality of fine tubes 33 provided in parallel with transfer paths for the coolant 71 which extend between the inflow opening 31 and the outflow opening 32. The plurality of fine tubes 33 are provided with fins 34 for releasing outside the heat of the coolant 71 that flows through the fine tubes 33.

The radiator 30, particularly the plurality of fine tubes 33 and the fins 34, is made from metal having a good heat conductivity. As such, the heat of the coolant 71 is released to an atmosphere via the fins, while the coolant 71 flows through the plurality of fine tubes 33. For further improvement of a cooling effect, there may be provided a fan for directing air to the plurality of fine tubes 3, or the radiator 30 may be cooled by directing thereto an airflow generated when an automobile moves.

A positional relation between the pump 14 and the radiator 30 is not limited to a positional relation illustrated in FIG. 9. Either one of the pump 14 and the radiator 30 can be provided upstream to the other with respect to a flow direction of the coolant 71. The pump 14 and the radiator 30 may be housed in a housing 10 or provided outside the housing 10.

(Effect of Headlamp 100)

The headlamp 100 is configured so that the coolant 71 is circulated through the paths which are in communication with the member provided outside the reflection mirror 8. This can increase a cooling effect of the coolant 71. With the arrangement of the headlamp 100, it is therefore possible to efficiently cool the light-emitting section 7 even in a case where the space defined by the reflection mirror 8 and the transparent plate 9, which space serves as the coolant reservoir, is small in size (that is, a storage amount of the coolant 71 is small).

### Embodiment 4

Still another embodiment of the present invention is described below with reference to FIGS. 10 through 12. Note that a member similar to each member described in Embodiments 1 through 3 are given a same reference numeral, and its description is omitted.

FIG. 10 is a cross-sectional view illustrating an arrangement of a headlamp 110 of the present embodiment. According to the headlamp 110, a reflection mirror 8 has neither an outflow opening 81 nor an inflow opening 82, a coolant 71 is sealed inside a space 80 (see FIG. 10). Instead of the outflow opening 81 and the inflow opening 82, a fin (heat dissipation section) 83 for cooling the coolant 71 is provided to the reflection mirror 8.

The light-emitting section 7 generates heat, and thus, the coolant 71 is heated by the heat near the light-emitting section 7. A heated portion of the coolant 71 rises with respect to a vertical direction of the reflection mirror 8, and an unheated portion of the coolant 71 moves closer to the light-emitting section 7. Since such a convection phenomenon occurs, it is not necessarily needed to circulate the coolant 71 by using a circulation device. In this case, however, it is thought that a heat quantity of the entire coolant 71 is kept being increased while the light-emitting section 7 is generating the heat. In view of this, it is preferable to cool the coolant 71.

It this regard, the headlamp 110 is arranged so that the reflection mirror 8 is made from a material (e.g., metal) having a good heat conductivity, and the reflection mirror 8 has a fin 83 provided on an outward-side surface. The fin 83 is provided for releasing outside the heat conducting from the reflection mirror 8 via the coolant 71.

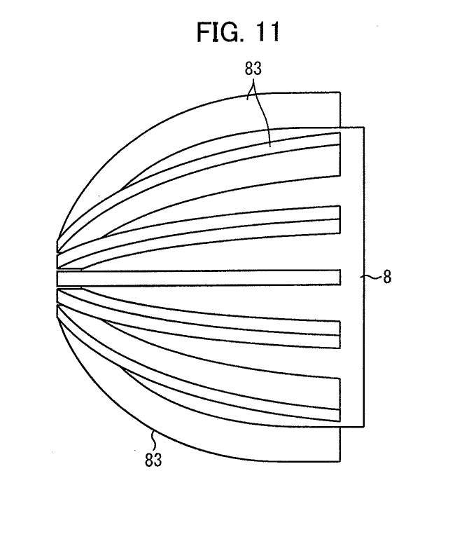

FIG. 11 is a view schematically illustrating how the plurality of fins 83 are provided. As illustrated in FIG. 11, the plurality of fins 83 are provided radially on an outer surface of the reflection mirror 8. The plurality of fins 83 serve to increase a surface area of the outer surface of the reflection mirror 8 so as to improve an efficiency of heat release from the coolant 71 to the atmosphere. A member other than the plurality of fins 83 can be used as the heat dissipation section, provided it serves as described above. For example, such protrusions as a plurality of rods can be provided, as the heat dissipation section, on the outer surface of the reflection mirror 8.

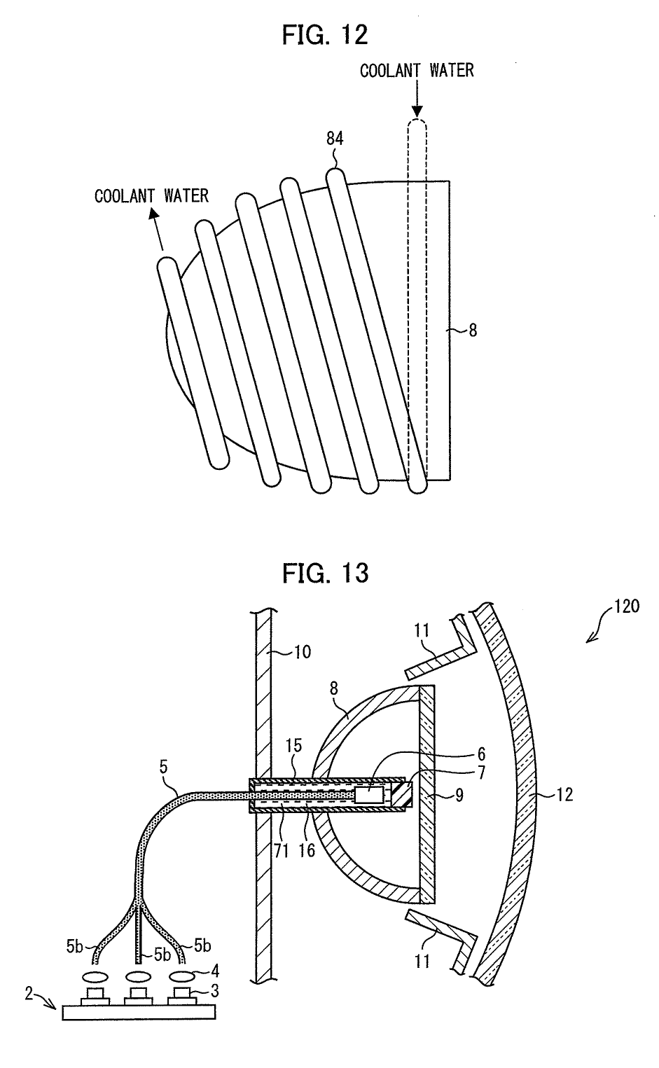

FIG. 12 is a view illustrating an example of how the reflection mirror 8 is cooled by coolant water. As illustrated in FIG. 12, the outer surface of the reflection mirror 8 may be provided with a cooling tube 84 through which a coolant different from the coolant 71 is circulated. The reflection mirror 8 can be cooled by letting the coolant flow through the cooling tube 84.

An air-cooling system that directs air to the reflection mirror 8 may be employed as a method for cooling the reflection mirror 8. In this case, an air blower that directs air to the reflection mirror should be provided as a cooling device. Instead of the air blower, a Peltier element may be provided as the cooling device for cooling the reflection mirror 8.

As described above, the reflection mirror 8 can be cooled by natural cooling or forcibly cooled by using the cooling device.

(Modified Example)

The headlamp 1110 may include a stirring device for stirring the coolant 71. For example, a rotary member for stirring the coolant 71 may be provided on the inward side of the reflection mirror 8. The rotary member may include a plurality of blades or have a rod-like shape. In order for the reflection mirror 8 to avoid having a hole which allows passage of a rotary shaft for rotating the rotary member, it is possible to employ a magnetized rotary bar and rotate it by applying a magnetic force thereto from an outside of the reflection mirror 8.

### Embodiment 5

Still another embodiment of the present invention is described below with reference to FIG. 13. Note that a member same as each member described in Embodiments 1 through 4 is given a same reference numeral, and its description is omitted.

FIG. 13 is a cross-sectional view illustrating an arrangement of a headlamp 120 of the present embodiment. As illustrated in FIG. 13, the headlamp 120 is arranged so that a light-emitting section 7 is fixed to a tip of a tube-shaped section 15 extending through a center of a reflection mirror 8. In this case, an optical fiber 5 can be inserted into the tube-shaped section 15.

A coolant 71 may be stored in an inside of the tube-shaped section 15. The tube-shaped section 15 having such an arrangement serves as a coolant reservoir in which a coolant fluid can be stored. A capacity of the tube-shaped section 15 is small. A capacity of the tube-like shape 15 is small. As such, in a case of storing the coolant 71 inside the tube-shaped section 15 instead of the space 80, it is preferable to circulate the coolant 17 inside the tube-shaped section 15 by use of a circulation system similar to the circulation system employed in the headlamp 100. Of course, the coolant 71 can be stored both inside the space 80 and the tub-shaped section 15.

A temperature of that part of the light-emitting section 7, which is irradiated with laser beam, (laser beam irradiation surface) is increased most. Thus, even with the arrangement that the coolant 71 is stored in the tube-shaped section 15, it is possible to lower a temperature of the light-emitting section 7 by cooling the laser beam irradiation surface.

In a case of employing the tube-shaped section 15 which is made from a metal having a good heat conductivity, it is possible to obtain such a cooling effect that the tub-shaped section 15 cools the light-emitting section 7.

### Embodiment 6

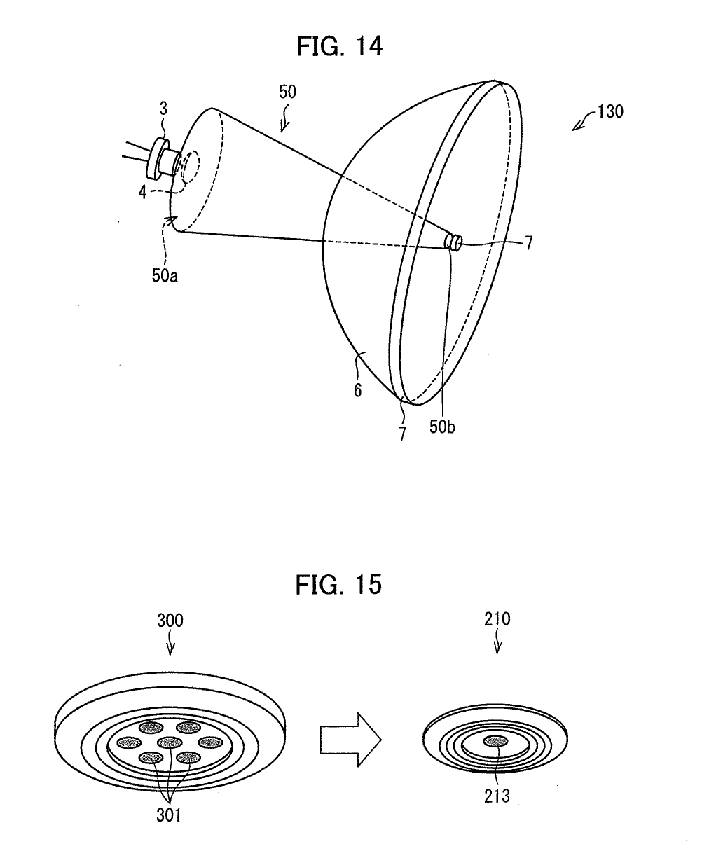

Still another embodiment of the present invention is described below with reference to FIG. 14. Note that a member similar to each member described in Embodiments 1 through 5 is given a reference numeral, and its description is omitted.

FIG. 14 is a perspective view illustrating an arrangement of a headlamp 1130 of the present embodiment. As shown in FIG. 14, a light guide section 50 may be provided, as a light member, in replacement of the optical fiber 5. An arrangement other than this is similar to the arrangements of the respective headlamps 1, 90, 100, and 110.

The light guide 50 is a light guide member having a truncated cone shape. The light guide 50 collects laser beam emitted from a laser diode 3 and guides it toward a light-emitting section 7 (i.e., a laser beam irradiation surface of the light-emitting section 7). The light guide 50 is optically connected to the laser diode 3 via an aspheric lens 4. The light guide section 50 has a light incident entrance 50a (entrance end section) for receiving the laser beam emitted from the laser diode 3 and a light emission surface 50b (light emission section) for emitting the laser beam thus received toward the light-emitting section 7.

An area of the light emission surface 50b is smaller than that of the light entrance surface 50a. Thus, the laser beam which has entered the light entrance surface 50a is reflected by a side surface of the light guide 50 while traveling forward, and converges as it is reflected as such.

The laser beam thus converged is emitted from the light emission surface 50b.

The light guide section 50 is made from BK7, quartz glass, acrylic resin, or any other transparent material. Shapes of the light entrance surface 50a and the light emission surface 50b can be planar or curved shapes.

The light guide section 50 may have a truncated pyramid shape. The light guide section 50 is not particularly limited in shape, provided that it can direct, toward the light-emitting section 7, laser beam emitted from the laser diode 3.

### Embodiment 7

Still another embodiment of the present invention is described below with reference to FIGS. 15 through 20. A member similar to each member described in Embodiments 1 through 6 is given a same reference numeral, and its description is omitted.

The following deals with a laser downlight 200 as an example of an illumination device of the present invention. The laser downlight 200 employs, in a laser downlight, a basic arrangement of the headlamp 1 described in Embodiment 1.

The laser downlight 200 is an illumination device installable on a ceiling of a structural object such as a building, a vehicle, or the like. The laser downlight 200 uses, as illumination light, fluorescent light which is emitted by irradiating a light-emitting section 7 with laser beam emitted from a laser diode 3. According to the laser downlight 200, cooling of the light-emitting section 7 is carried out by use of a cooling device 20.

An illumination device having an arrangement similar to the arrangement of the laser downlight 200 can be installed on a side wall or a floor of the structural object. Where to install the illumination device is not particularly limited.

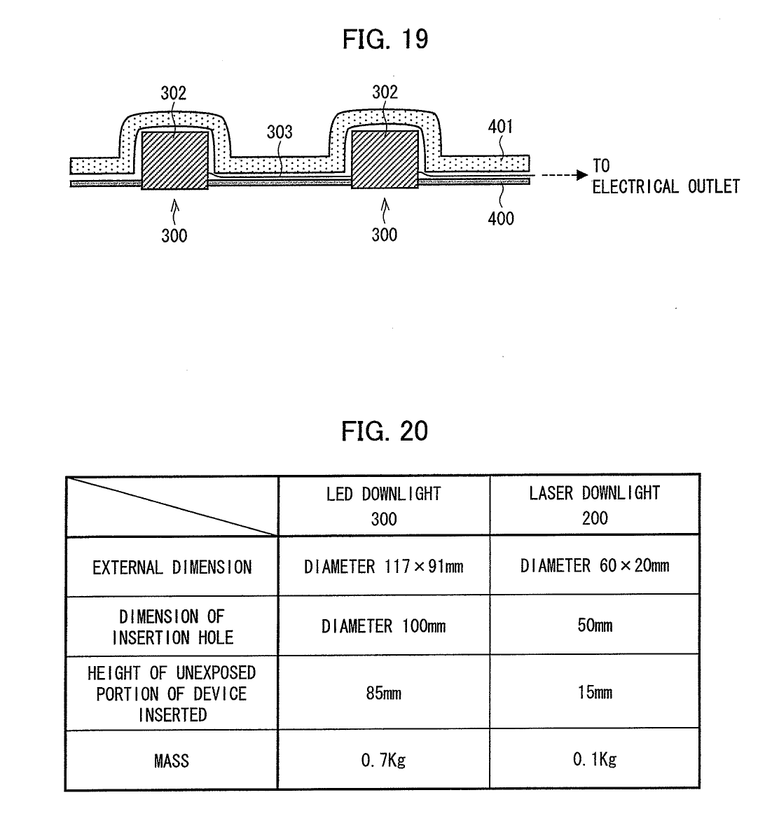

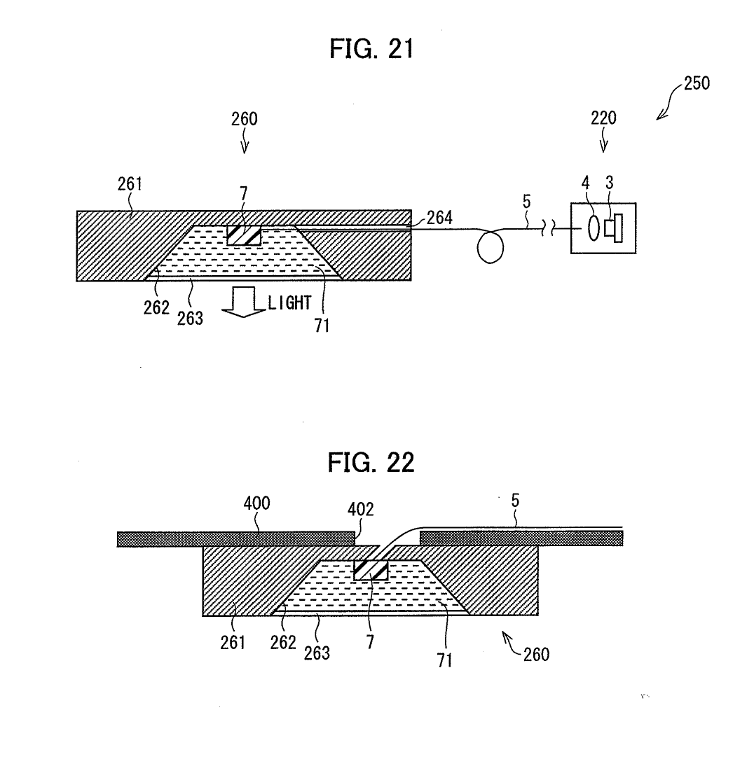

FIG. 15 is a view schematically illustrating an exterior appearance of a light-emitting unit 210 and that of a conventional LED downlight 300. FIG. 16 is a cross-sectional view illustrating a ceiling onto which the laser downlight 200 is installed. FIG. 17 is a cross-sectional view illustrating the laser downlight 200. As illustrated in FIGS. 15 through 17, the laser downlight 200 is buried in a ceiling 400, and the laser downlight 200 includes a light-emitting unit 210 for emitting illumination light, an LD light source unit 220 for supplying laser beam to the light-emitting unit 210 via an optical fiber 5, and the cooling device 20 for directing air to the light-emitting unit 210 via a nozzle 21 so as to cool the light-emitting section 7. The LD light source unit 220 and the cooling device 20 are not provided on the ceiling, but are provided on such a location (e.g., a side wall of a building) where a user can easily touch them. Locations of respective of the LD light source unit 220 and the cooling device 20 can be thus freely determined, because the LD light source unit 220 and the cooling device 20 are connected to the light-emitting unit 210 respectively via the optical fiber 5 and the nozzle 21. The optical fiber 5 is provided in a gap between the ceiling 400 and a heat shield material 401.

(Arrangement of Light-Emitting Unit 210)

As illustrated in FIG. 17, the light-emitting unit 210 includes a housing 211, the optical fiber 5, the light-emitting section 7, and a light-transmitting plate 213.

The housing 211 has a recession section 212. The light-emitting section 7 is provided on a bottom surface of the recession section 212. The recession section 212 are coated by a metal thin film, and thus functions as a reflection mirror.

The housing 211 has a path 214 via which the optical fiber 5 and the nozzle 21 are led inside the housing 211. The optical fiber 5 and the nozzle 21 extend via the path 214 to the light-emitting section 7. Positional relations between the light-emitting section 7 and each of an emission end section 5a of the optical fiber 5 and an outlet section 21a of the nozzle 21 are similar to the positional relations early described.

The light-transmitting plate 213 is a light-transmitting or semi-light-transmitting plate, and is provided so as to seal an opening part of the recession section 212. The light-transmitting plate 213 has a function similar to that of the transparent plate 9. Thus, fluorescent light emitted from the light-emitting section 7 is transmitted through the light-transmitting plate 213 and emitted as illumination light. The light-transmitting plate 213 may be detachable with respect to the housing 211 or may be omitted.

In an arrangement illustrated in FIG. 15, an outer edge of the light-emitting unit 210 is shaped circular. However, a shape (more specifically, a shape of the housing 211) of the light-emitting unit 210 is not limited to a particular one.

A downlight is different from a headlamp in terms that no ideal dot-light source is required, and a single emission point is satisfactory. In the case of the downlight, therefore, limitations on the shape, size, and location of the light-emitting section 7 are less as compared in a case of the headlamp.

(Arrangement of LD Light Source Unit 220)

The LD light source unit 220 includes a laser diode 3, an aspheric lens 4, and an optical fiber 5.

An entrance end section 5b, which is an end section of one end of the optical fiber 5, is connected to the LD light source unit 220. Laser beam emitted from the laser diode 3 enters the entrance end section 5b of the optical fiber 5 via the aspheric lens 4.

FIG. 17 illustrates that only a single combination of the laser diode 3 and the aspheric lens 4 are provided inside the LD light source unit 220. In a case where a plurality of light-emitting units 210 are provided, a bundle of optical fibers 5 extending from the respective plurality of light-emitting units 210 can be led to a single LD light source unit 210. In this case, a plurality of combinations each made up of laser diodes 3 and an aspheric lens 4 (or a combination made up of a plurality of laser diodes 3 and a single rod-shaped lens (which is not illustrated in the drawings)) are housed in the single LD light source unit 220. As such, the LD light source unit 220 functions as a concentrated power supply box.

(Modified Example of Installation Method of Laser Downlight 200)

FIG. 18 is a cross-sectional view illustrating a modified example of an installation method of the laser downlight 200. As illustrated in FIG. 18, the modified example of the installation method of the laser downlight 200 may include (i) opening a small hole 402 in the ceiling 400 for allowing passage of the optical fiber 5 and the nozzle 21, and (ii) attaching a laser downlight body (the light-emitting unit 210) to the ceiling by taking advantage of features, which are reduced thickness and light weight, of the laser downlight body. With the modified example of the installation method of the laser downlight 200, it is possible to obtain a merit that limitations on the installation of the laser downlight 200 are less significant and a great reduction in construction cost is obtained.

(Comparison of Laser Downlight 200 and Conventional LED Downlight 300)

As illustrated in FIG. 15, the conventional LED downlight 300 includes a plurality of light-transmitting plates 301. The conventional LED downlight 300 emits illumination light from each of the light-transmitting plates 301. That is, the LED downlight 300 has a plurality of emission points. This is because a light beam emitted from each of the plurality of emission points is relatively small. As such, unless the plurality of emission points are provided, it is impossible to obtain a light beam sufficient as illumination light.

On the other hand, the laser downlight 200 is an illumination apparatus which emits a high luminous flux. As such, even a single emission point is satisfactory for the laser downlight 200. Under illumination light emitted from only the single emission point, it is possible to obtain clear shade. Further, by employing a fluorescent substance of a high color render index (e.g., a combination of oxynitride fluorescent substance of a few kinds) as the fluorescent substance of the light-emitting section 7, it is possible to improve a color render index of the illumination light.

FIG. 19 is a cross-sectional view illustrating a ceiling provided with the LED downlight 300. As illustrated in FIG. 19, the LED downlight 300 is installed so that a housing 302, in which an LED chip, an electric power supply, and a cooling unit are housed, is buried in a top board 400. The housing 302 is relative large, and thus, that part of a heat shield material 401 which is provided for a region where the housing 302 is located has a recession section corresponding to a shape of the housing 302. A power supply line 303 extends from the housing 302, and is connected to an electrical outlet (which is illustrated in the drawings).

The arrangement above gives rise to a problem described as follows. The light source (LED chip) and the electric power source, both of which generate heat, are provided between the top board 400 and the heat shield material 401. As such, each time when the LED downlight 300 is used, a temperature of the ceiling is increased, thereby causing a decrease in an efficiency of cooling of a room.

The LED downlight 300 also gives rise to a problem that, since an electric power supply is necessary for each light source, total cost is increased.

Further, the hosing 302 is relatively large. This gives rise to another problem that it is often difficult to locate the LED downlight 300 in a space between the top board 400 and the heat shield material 401.

On the other hand, the laser downlight 200 is arranged so that a member which generates heat within the light-emitting unit 210 is not large. Thus, there occurs no decrease in an efficiency of room cooling. This can prevent an increase in cost of the room cooling.

Further, since it is not necessary to provide an electric power source for each light-emitting unit 210, it is possible to achieve reductions in size and thickness of the laser downlight 200. This makes smaller limitations on a space where the laser downlight 200 is installable. As such, it can be easy to install the laser downlight 200 in a built residence.

Further, since the laser downlight 200 is small in size and thin in thickness, it is possible to install the light-emitting unit 210 on a surface of the top board 400, as described above. This can make limitation on installation smaller and obtain a great reduction in installation cost, as compared to a case where the LED downlight 300 is installed.

FIG. 20 is a table in which the laser downlight 200 and the LED downlight 300 are compared with each other in terms of their specifications. As exemplified in FIG. 20, a volume of the laser downlight 200 matches 6% of that of the LED downlight 300, and a mass of the laser downlight 200 matches 14% of that of the LED downlight 300.

Furthermore, the LD light source 220 can be provided at a location where it is easily accessible by the user. As such, even in a case where the laser diode 3 is broken, it is possible to easily change it. Likely, the cooling device 20 is provided at a location where it is easily accessible by the user. As such, even in a case where a cooling mechanism in the cooling device 20 is broken, it is possible to easily fix it. Further, by leading the optical fibers 5 from the respective plurality of the light-emitting units 210 to the single LD light source unit 220, it is possible to realize collective management of the plurality of laser diodes 3. As such, even in a case of changing the plurality of laser diodes 3, it is still possible to carry out easy changing of the plurality of laser diodes 3.

In a case of employing a fluorescent substance of high color render index in the LED downlight 300, it is possible to carry out emission of light flux of approximately 500 lm by electric power consumption of 10 W. However, in order for the laser downlight 200 to achieve light emission of same light intensity, it is necessary to employ light output of 3.3 W. In a case where an LD efficiency is 35%, the light output of 3.3 W corresponds to electric power consumption of 10 W.

Since the electric power consumption of the LED downlight 300 is 10 W, there is no great difference between the LED laser downlight 300 and the laser downlight 200 in terms of electric power consumption. Therefore, the laser downlight 200 can obtain the variety of merits by the electric power consumption same as that of the LED downlight 300.

The laser downlight 200 thus includes: the LD light source unit 220 including one or more laser diodes 3 for emitting laser beam; one or more light-emitting units 210 including the respective light-emitting sections 7 and the respective recession sections 212 serving as the reflection mirrors; the optical fiber(s) 5 provided for the respective one or more laser diodes 3 so as to direct the laser beam to the respective one or more light-emitting units 210; and the cooling device 20 for cooling the light-emitting device(s) 7 of the respective one or more light-emitting units 210. The laser downlight 200 may be arranged so that the cooling device 20 generates airflow and the nozzle 21 for directing the airflow to the light-emitting section(s) 7 is provided.

With the arrangement, it is possible to prevent temperature elevation in the irradiation region of the light-emitting section 7 of the laser downlight 200, which irradiation region is irradiated with laser beam. Thus, it is possible to realize the laser downlight 200 of long lifetime.

### Embodiment 8

Still another embodiment of the present invention is described below with reference to FIGS. 21 and 22. Note that a member similar to each member described in Embodiments 1 through 7 is given a same reference numeral, and a its description is omitted.

The following description deals with a laser downlight 250 as an example of the illumination device of the present invention. The laser downlight 250 is made by employing the basic arrangement of the headlamp 90 of Embodiment 2 to a laser downlight.

The laser downlight 250 is an illumination device installed on a ceiling of a structural object such as a building, a vehicle, or the like. The laser downlight 250 uses, as illumination light, fluorescent light generated by irradiating a light-emitting section 7 with laser beam emitted from a laser diode 3. According to an arrangement of the laser downlight 250, the light-emitting section 7 is cooled by use of a coolant 71.

As illustrated in FIGS. 21 and 22, the laser downlight 250 includes a light-emitting unit 260 and a LD light source unit 220. The LD light source unit 220 supplies laser beam to the light-emitting unit 260 via an optical fiber 5.

(Arrangement of Light-Emitting Unit 260)

As illustrated in FIG. 21, the light-emitting unit 260 includes a housing 261, the optical fiber 5, the light-emitting section 7, and a light-transmitting plate (light-transmitting section) 263.

The housing 261 has a recession section 262 similar to the recession section. The housing 261 also has a path 264 via which the optical fiber 5 is led. The optical fiber 5 extends to the light-emitting section 7 via the path 264.

The light-transmitting plate 263 is a plate similar to the light-transmitting plate 213.

The coolant 71 is stored in a space defined by the recession section 262 and the light-transmitting plate 263. In the case of the laser downlight 250, it is rarely the case that a light beam as intense as that of a headlamp is needed. As such, a circulation system as included in the headlamp 100 is not necessarily needed. It is thought that, by employing the housing 261 which is made from a material having a good heat conductivity (e.g., meal such as aluminum), it is possible to allow cooling of the coolant 71.

In a case of employing such cooling arrangement that the coolant 71 is circulated so as to be cooled, it is useful to provide single circulation and cooling systems (e.g., radiator 30, pump 14) for the plurality of light-emitting units 260. This can downsize a space required for installation of the laser downlight 250.

(Modified Example of Installation Method of Laser Downlight 250)

FIG. 22 is a cross-sectional view illustrating a modified example of the installation method of the laser downlight 250. As illustrated in FIG. 22, the modified example of the installation method of the laser downlight 250 may be arranged so as to include: opening, in a top board 400, only a small opening 402 for allowing passage of the optical fiber 5; and attaching a laser downlight body (light-emitting unit 260) to the top board 400 by taking advantage of features, which are a reduced thickness and a light weight, of the laser downlight body. With the arrangement, it is possible to bring about a merit that limitations on installation of the laser downlight 250 become less significant and a great reduction in construction cost is obtained.

(Other Modified Examples)

The present invention is not limited to the description of the embodiments above, but may be altered by a skilled person within the scope of the claims. An embodiment based on a proper combination of technical means as disclosed in different embodiments is encompassed in the technical scope of the present invention.

For example, a high-output LED can be used the excitation light source. In this case, a light-emitting device for emitting white light can be made by employing in combination (i) an LED for emitting light (blue light) of a wavelength of 450 nm and (ii) a yellow fluorescent substance or green and red fluorescent substances.

Instead of the high-output LED, a solid laser other than a laser diode can be used as the excitation light source. For example, a light-emitting diode capable of emitting a high output can be used. Note, however, that it is preferable to employ the laser diode as the excitation light, because this allows miniaturization of the excitation light source.

(Different Description of the Present Inventions)

Note that the invention of the present inventions can be different described as follows.

A light-emitting device (high-luminance light source) of the present invention includes: an excitation light source which is made up of a laser diode capable of emitting a high output; a light-emitting section which emits light when irradiated with excitation light emitted from the excitation light source; and a mechanism that directs a gas to a region where the excitation light enters the light-emitting section.

The light-emitting device of the present invention is arranged so that the excitation light source is not limited to the laser diode, but may be a high power light-emitting diode.

Furthermore, the light-emitting device of the present invention may be a laser diode having a single laser beam emission end for a single excitation light source, or may be a laser diode having a plurality of laser beam emission ends for the single excitation light source.

The light-emitting device of the present invention thus includes: the excitation light source for emitting the excitation light; the light-emitting section for emitting the light when irradiated with the excitation light emitted from the excitation light source; and a cooling section for cooling a temperature elevation region inclusive of an irradiation region, where the excitation light enters the light-emitting section, and a neighboring region of the irradiation region.

According to the arrangement, the light-emitting section emits light when irradiated with the excitation light emitted from the excitation light source. When the light-emitting section is irradiated with the excitation light, temperatures of the region inclusive of the irradiation region and the neighboring region is elevated (that is, the region becomes the temperature elevation region). However, the cooling section cools the temperature elevation region.

The light-emitting device thus includes the cooling section. With the arrangement, by preventing the increase in temperature of the temperature elevation region, it is possible to realize a light source of long lifetime. That is, the light-emitting device of the present invention can realize a high-luminance light source of high reliability.

Furthermore, it is preferable that the light-emitting device of the present invention be arranged so that the cooling section includes: an air blasting section for generating airflow which is send to the temperature elevation region; and an air guiding section including an inlet section for receiving the airflow generated by and sent from the air blasting section and an outlet section for outputting the airflow coming from the receiving section, the outlet section being provided near the temperature elevation region.

According to the arrangement, the airflow generated by the air blasting section enters the inlet section of the air guiding section, and is outputted from the outlet section of the air guiding section near the temperature elevation region. In the light-emitting device, it is therefore possible that the airflow generated by the air blasting section arrives the temperature elevation region, thereby cooling the temperature elevation region.

Furthermore, it is preferable that the light-emitting device of the present invention be arranged so that the light-emitting section is supported by the outlet section.

According to the arrangement, the light-emitting section is supported by the outlet section. This allows such efficient use of the air guiding section that the air guiding section directs the airflow generated by the air blasting section to the temperature elevation region and supports the light-emitting section.

Furthermore, it is preferable that the light-emitting device of the present invention further include a light guiding section having an entrance end section for receiving the excitation light emitted from the excitation light source and an emission end section for emitting the excitation light thus received, the emission end section of the light guiding section being inserted to an inside of the air guiding section.

According to the arrangement, the excitation light emitted from the excitation light source enters the entrance end section of the light guiding section, and is emitted from the emission end section of the same. Since the emission end section of the light guiding section is inserted into the inside of the air guiding section, it is possible to achieve a reduction in a space, as compared to an arrangement in which the light guiding section and the air guiding section are provided separately from each other.

Further, according to the arrangement, the outlet section for outputting the airflow generated by the air blasting section and the emission end section for emitting the excitation light emitted from the excitation light source are integrated to each other. This allows designing, which is made by taking into account, for example, (i) a length of the air guiding section, a distance between the outlet section and the light-emitting section (which is a surface to be irradiated with the excitation light), (iii) a direction of the air guiding section which direction is set by taking into account an entry angle of the airflow with respect to the light-emitting section (the temperature elevation region), and the like, to be easier as compared to a case where the light guiding section and the air guiding section are provided separately from each other.

Furthermore, it is preferable that the light-emitting device of the present invention be arranged so that the air guiding section is flexible.

According to the arrangement, the air guiding section is flexible. This allows easy modification of positional relationship between the inlet section and the outlet section, thereby allowing easy modification of the positional relationship between the air guiding section and the light-emitting section. With the arrangement, it is therefore possible to improve degrees of freedom in design of the light-emitting device.

A light-emitting device of the present invention includes: an excitation light source for emitting excitation light; a light-emitting section for emitting light when irradiated with the excitation light emitted from the excitation light source; and a coolant reservoir in which a coolant for cooling the light-emitting section is stored.

According to the arrangement, the light-emitting section emits light when irradiated with the excitation light emitted from the excitation light source. In this case, the irradiation of the excitation light causes the light-emitting section to generate heat. The coolant reservoir stores the coolant for cooling the light-emitting section. That is, the light-emitting section is cooled by the coolant stored in the coolant reservoir.

The coolant is convected by heat conducting from the light-emitting section or can be artificially stirred or circulated. This makes it to change the coolant which is in contact with the light-emitting section. It is therefore possible to efficiently cool the light-emitting section by use of the coolant.

Furthermore, it is preferable that the light-emitting device of the present invention further include: a reflection mirror where light emitted from the light-emitting section is reflected so as to form light flux that travels within a predetermined solid angle; and a light-transmitting plate attached to the reflection mirror and allowing passage of the light flux, the reflection mirror and the light-transmitting plate defining at least a part of the coolant reservoir.

According to the arrangement, the light emitted from the light-emitting section is reflected by the reflection mirror so that the light flux traveling within the predetermined solid angle will be emitted. The reflection mirror and the light-transmitting plate attached to the reflection mirror form at least a part of the coolant reservoir.

Thus, the inward side of the reflection mirror can be filled with the coolant, and this allows the light-emitting section provided on the inward side of the reflection mirror to be cooled by the coolant.

Furthermore, it is preferable that the coolant reservoir have an inflow opening via which the coolant flows in and an outflow opening via which the coolant is discharged.

With the arrangement, it is possible to change the coolant in the coolant reservoir by discharging the coolant via the discharge opening and feeding the coolant via the inflow opening. For example, it is possible to circulate the coolant by discharging the coolant via the discharge opening and feeding back, via the inflow opening, the coolant thus discharged.

Thus, by changing a heated portion of the coolant, which is heated near the light-emitting section, with an unheated portion of the coolant, it is possible to improve a cooling efficiency.

Furthermore, it is preferable that the light-emitting device of the present invention further include a pump for causing such circulation that the coolant discharged from the outflow opening is fed back into the coolant reservoir through the inflow opening.

With the arrangement, it is possible to use the pump to cause such circulation of the coolant in the coolant reservoir that some portion of the coolant, which is discharged from the outflow opening by feeding another portion of the coolant through the inflow opening, is fed back into the coolant reservoir through the inflow opening. It is therefore possible to achieve the circulation of the coolant stored in the coolant reservoir.

Furthermore, it is preferable that the reflection mirror includes a heat dissipation section for dissipating heat of the coolant.

According to the arrangement, the heat dissipation section thus provided to the reflection mirror allows heat dissipation of the coolant. Thus, it is possible to cool the coolant which has been heated by the heat conducting from the light-emitting section.

An illumination apparatus of the present invention includes any of the light-emitting devices described above and a reflection mirror whereby light emitted that light-emitting device is reflected so as to form light flux that travels within a predetermined solid angle.

According to the arrangement, the light emitted from the light-emitting section is reflected by the reflection mirror so as to form the light flux traveling within the predetermined solid angle. It is therefore possible to realize a small-sized illumination device of high luminance and long lifetime which is suitable for a vehicle headlamp or a searchlight.

It is preferable that the illumination device of the present invention includes any of the light-emitting devices described above and the reflection mirror whereby the light emitted from the light-emitting section is reflected so as to form the light flux that travels within the predetermined solid angle, wherein: the reflection mirror is curved-shaped and has an opening section opening in a direction in which the light flux travels; the light-emitting device is provided in a space surrounded by the reflection mirror and a transparent material covering the opening section of the reflection mirror and allowing passage of the light flux; and the reflection mirror has one or more hole sections for emitting airflow retained inside the space.

According to the arrangement, the illumination device is provided in the space surrounded by (i) the reflection mirror being curved-shaped and having the opening section opening in the direction in which the light flux travels and (ii) the transparent material covering the reflection mirror. Thus, in a case where the airflow generated by the air blasting section is directed from the outlet section of the air guiding section to the temperature elevation region, the airflow thus directed is heated in the temperature region and retained in the space. This gives rise to a risk that the cooling efficiency is deteriorated.

However, the illumination device of the present invention is arranged so that the reflection mirror has one or more hole sections for emitting the airflow retained in the space. Since this allows the airflow thus heated in the temperature elevation region to be emitted outside through the one or more hole sections, it is possible to prevent retention of the airflow in the space. In the illumination device, it is therefore possible to lower the risk that the cooling efficiency is deteriorated in the temperature elevation region.

An illumination device and a vehicle headlamp, each including any of the light-emitting devices, are encompassed in the technical scope of the present invention.

### INDUSTRIAL APPLICABILITY

The present invention can be applied to a light-emitting device of high luminance and long lifetime, particularly to a headlamp for use in a vehicle or the like.

### REFERENCE SIGNS LIST

1 headlamp (light-emitting device, illumination device, vehicle headlamp)
2 laser diode array (excitation light source)
3 laser diode (excitation light source)
5 optical fiber (light guide section)
5a emission end section
5b entrance end section
7 light-emitting section
8 reflection mirror
9 transparent plate (transparent member)
20 cooler (cooling section, air blowing section)
21 nozzle (cooling section, air guiding section)
21a outlet section
21b inlet section
22 hole section
90 headlamp (light-emitting device, illumination device, vehicle headlamp)
100 headlamp (light-emitting device, illumination device, vehicle headlamp)
110 headlamp (light-emitting device, illumination device, vehicle headlamp)
120 headlamp (light-emitting device, illumination device, vehicle headlamp)
130 headlamp (light-emitting device, illumination device, vehicle headlamp)
200 LED downlight (illumination device)
250 LED downlight (illumination device)

1. A light-emitting device comprising:
an excitation light source for emitting excitation light;
a light-emitting section for emitting light in response to the excitation light; and
a cooling section for cooling the light-emitting section with use of a fluid.

2. The light-emitting device according to claim 1,
wherein:
the cooling section cools a temperature elevation region of the light-emitting section, the temperature elevation region including (i) an irradiation region upon which the excitation light falls and (ii) a region present in a vicinity of the irradiation region.

3. The light-emitting device according to claim 2,
wherein:
the cooling section includes:
an air blowing section for blowing air toward the temperature elevation region; and
an air guiding section including (i) an inlet section through which the air flows in and (ii) an outlet section through which the air having flown in through the inlet section flows out; and
the outlet section is present in a vicinity of the temperature elevation region.

4. The light-emitting device according to claim 3,
wherein:
the light-emitting section is supported by the outlet section.

5. The light-emitting device according to claim 3, further comprising:
a light guide section including:
an entrance end section for receiving the excitation light; and
an emission end section for emitting the excitation light received by the entrance end section,
the emission end section is inserted in the air guiding section.

6. The light-emitting device according to claim 3,
wherein:
the air guiding section is flexible.

7. The light-emitting device according to claim 1,
wherein:
the cooling section is a coolant reservoir reserving a coolant for cooling the light-emitting section.

8. The light-emitting device according to claim 7, further comprising:
a reflection mirror for reflecting the light, emitted by the light-emitting section, so as to form a bundle of rays traveling within a predetermined solid angle; and
a light-transmitting plate combined with the reflection mirror so as to transmit the bundle of rays,
the reflection mirror and the light-transmitting plate forming at least a part of the coolant reservoir.

9. The light-emitting device according to claim 7,
wherein:
the coolant reservoir has (i) an inflow opening through which the coolant flows in and (ii) a discharge opening through which the coolant is discharged.

10. The light-emitting device according to claim 9, further comprising:
a pump for allowing the coolant having been discharged through the discharge opening to return to the coolant reservoir through the inflow opening.

11. The light-emitting device according to claim 8,
wherein:
the reflection mirror includes a heat dissipation section for causing heat of the coolant to dissipate.

12. An illumination device comprising:
the light-emitting device recited in claim 1; and
a reflection mirror for reflecting the light, emitted by the light-emitting section, so as to form a bundle of rays traveling within a predetermined solid angle.

13. An illumination device comprising:
the light-emitting device recited in claims 3; and
a reflection mirror for reflecting the light, emitted by the light-emitting section, so as to form a bundle of rays traveling within a predetermined solid angle,
the reflection mirror having a curved surface so as to have an opening facing in a direction in which the bundle of rays travels,
the light-emitting device being provided in a space defined by (i) the reflection mirror and (ii) a transparent member covering the opening of the reflection mirror and transmitting the bundle of rays,
the reflection mirror having at least one hole section for releasing air remaining in the space.

14. A vehicle headlamp comprising:
the light-emitting device recited in claim 1.
